(19) United States
(12) Patent Application Publication
(10) Pub. No.: US 2025/0165708 A1
(43) Pub. Date: May 22, 2025

(54) INFORMATION PROCESSING DEVICE, INFORMATION PROCESSING METHOD, AND NON-TRANSITORY COMPUTER READABLE STORAGE MEDIUM

(71) Applicant: LY Corporation, Tokyo (JP)

(72) Inventors: Satoshi FUKUYAMA, Tokyo (JP); Daisuke AKAZAWA, Tokyo (JP)

(21) Appl. No.: 18/907,875

(22) Filed: Oct. 7, 2024

(30) Foreign Application Priority Data
Nov. 20, 2023 (JP) 2023-196775

(51) Int. Cl. G06F 40/20; H04W 4/38

(52) U.S. Cl. CPC G06F 40/20; H04W 4/38

(57) ABSTRACT

An information processing device according to the application concerned includes a display control unit, a receiving unit, an obtaining unit, and a generating unit. The display control unit displays, in a terminal device of a user, a button meant for obtaining, from the terminal device, sensor detection information in a service which is based on the dialogue format using a generative AI that outputs answer information corresponding to the input information. The receiving unit receives the selection of the button as made by the user. When the receiving unit receives selection of the button, the obtaining unit obtains the sensor detection information. The generating unit generates information that corresponds to the sensor detection information obtained by the obtaining unit and that is included in the input information to be input to the generative AI.

### CROSS REFERENCE TO RELATED APPLICATIONS

This application claims priority based on Japanese patent application No. 2023-196775, filed on Nov. 20, 2023, the entire contents of which are incorporated herein by reference.

### BACKGROUND OF THE INVENTION

### 1. Field of the Invention

The present invention relates to an information processing device, an information processing method, and a non-transitory computer readable storage medium.

### 2. Description of the Related Art

Conventionally, a service is known that exchanges messages with the user in the form of a conversation. For example, in Japanese Patent Application Laid-open No. 2022-180282, a technology is proposed in which input messages input by the user in the form of utterances are received; information containing the input messages is input to a generative AI such as a language model; and the generative AI is made to generate response messages.

### SUMMARY OF THE INVENTION

However, in the technology mentioned above, for example, there is no disclosure of a technology for appropriately obtaining the information about a user with the aim of enhancing the accuracy of the response messages corresponding to the input messages received from the user. Hence, there is room for improvement regarding appropriately obtaining the information about the user.

An information processing device includes a display control unit, a receiving unit, an obtaining unit, and a generating unit. The display control unit displays, in a terminal device of a user, a button meant for obtaining, from the terminal device, sensor detection information in a service which is based on dialogue format using a generative AI that outputs answer information corresponding to input information. The receiving unit receives selection of the button as made by the user. The obtaining unit obtains the sensor detection information when the receiving unit receives selection of the button. The generating unit generates information which corresponds to the sensor detection information obtained by the obtaining unit and which is included in input information to be input to the generative AI.

### BRIEF DESCRIPTION OF THE DRAWINGS

FIG. 1 is a diagram for explaining the information processing performed according to an embodiment;

FIG. 2 is a diagram illustrating an exemplary configuration of an information processing system according to the embodiment;

FIG. 3 is a diagram illustrating an exemplary configuration of an information processing device according to the embodiment;

FIG. 4 is a diagram illustrating an example of a user information table that is stored in a user information storing unit of the information processing device according to the embodiment;

FIG. 5 is a diagram illustrating an example of a dialogue data table that is stored in a dialogue data storing unit of the information processing device according to the embodiment;

FIG. 6 is a diagram for explaining an example of the operations performed by a processing unit of the information processing device according to the embodiment;

FIGS. 7A-7D are diagrams (1) illustrating an example of the information placed in a chatroom that is displayed in a terminal device according to the embodiment;

FIGS. 8A-8D are diagrams (2) illustrating an example of the information placed in the chatroom that is displayed in the terminal device according to the embodiment;

FIG. 9 is a diagram illustrating an example of dialogue data that is generated by a generating unit of the processing unit of the information processing device according to the embodiment;

FIG. 10 is a diagram illustrating an example of location information that is added as variable information about the user in the dialogue data by the generating unit of the processing unit of the information processing device according to the embodiment;

FIG. 11 is a diagram illustrating an example of the dialogue data that has been updated by the generating unit of the processing unit of the information processing device according to the embodiment;

FIG. 12 is a diagram (1) illustrating an example of a dialogue history that is added to the dialogue data by the generating unit of the processing unit of the information processing device according to the embodiment;

FIG. 13 is a diagram (2) illustrating an example of a reservation history that is added to the dialogue data by the generating unit of the processing unit of the information processing device according to the embodiment;

FIG. 14 is a diagram illustrating an example of the input information that is to be input to a generative AI by an obtaining unit of the processing unit of the information processing device according to the embodiment;

FIG. 15 is a diagram (1) illustrating an example of the information about a function related to searching as included in the function information illustrated in FIG. 14;

FIG. 16 is a diagram (2) illustrating an example of the information about a function related to questioning as included in the function information illustrated in FIG. 14;

FIG. 17 is a diagram (3) illustrating an example of the information about a function related to reservation as included in the function information illustrated in FIG. 14;

FIG. 18 is a diagram illustrating another example of the input information that is to be input to the generative AI by the obtaining unit of the processing unit of the information processing device according to the embodiment;

FIG. 19 is a diagram illustrating still another example of the input information that is to be input to the generative AI by the obtaining unit of the processing unit of the information processing device according to the embodiment;

FIG. 20 is a diagram illustrating a different example of the input information that is to be input to the generative AI by the obtaining unit of the processing unit of the information processing device according to the embodiment;

FIG. 21 is a flowchart for explaining an example of the information processing performed by the processing unit of the information processing device according to the embodiment;

FIG. 22 is a flowchart for explaining an example of a search operation performed by the processing unit of the information processing device according to the embodiment;

FIG. 23 is a flowchart for explaining an example of a questioning operation performed by the processing unit of the information processing device according to the embodiment;

FIG. 24 is a flowchart for explaining an example of a reservation operation performed by the processing unit of the information processing device according to the embodiment; and

FIG. 25 is a hardware configuration diagram illustrating an example of a computer that implements the functions of the information processing device according to the embodiment.

### DETAILED DESCRIPTION OF THE PREFERRED EMBODIMENTS

An illustrative embodiment (hereinafter, called an “embodiment”) of an information processing device, an information processing method, and a computer program product according to the application concerned is described below in detail with reference to the accompanying drawings. However, the information processing device, the information processing method, and the computer program product according to the application concerned are not limited by the embodiment. Meanwhile, embodiments can be appropriately combined without causing contradiction in the operation details. In the embodiments described below, identical constituent elements are referred to by the same reference numerals, and their explanation is not given repeatedly.

### 1. Example of the Information Processing

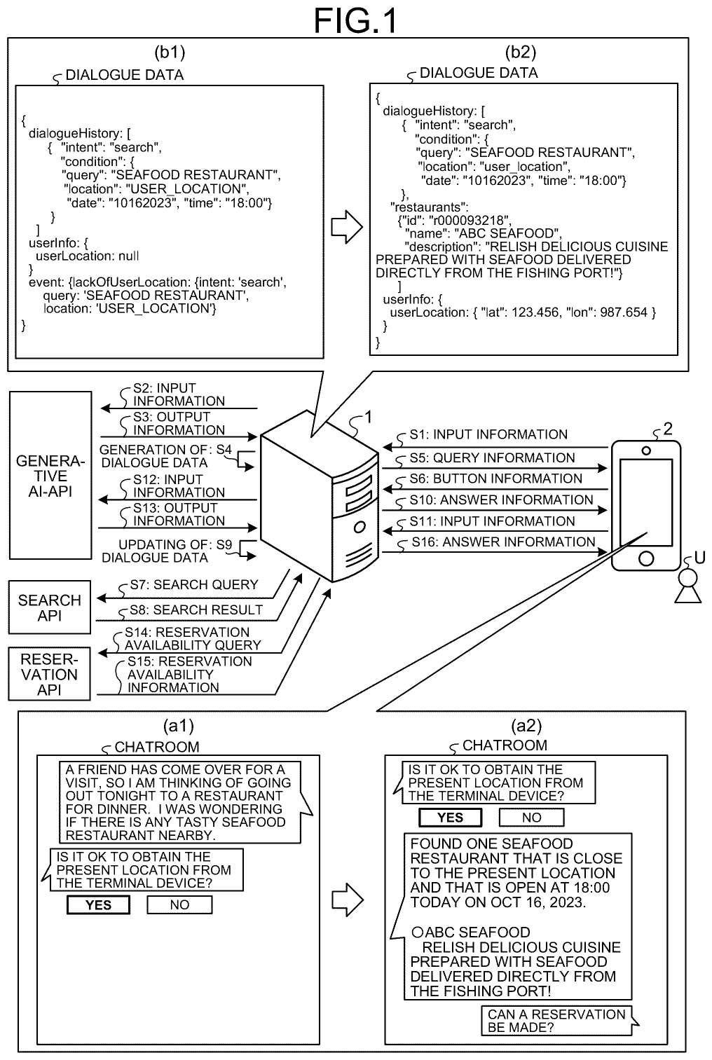

Firstly, explained below with reference to FIG. 1 is an example of the information processing performed according to the embodiment. FIG. 1 is a diagram for explaining the information processing performed according to the embodiment.

An information processing device 1 illustrated in FIG. 1 coordinates with a terminal device 2 of a user U and provides the user U with a variety of information online. For example, the information processing device 1 is implemented using one or more servers or cloud systems. The terminal device 2 is, for example, a smartphone or a tablet. In the example illustrated in FIG. 1, although only a single terminal device 2 is illustrated, the information processing device 1 coordinates with each of a plurality of terminal devices 2 and provides the user of each terminal device 2 with various services online.

The service provided by the information processing device 1 to the user U is carried out in the form of a conversation with the user U using a generative AI (Artificial Intelligence) that outputs response information corresponding to the input information. For example, the service is designed for specific use.

The generative AI is, for example, a text generative AI. For example, a text generative AI is a large-scale language model trained to estimate and output subsequent tokens from the input token string. For example, a text generative AI is a transfer-based model or a model based on a recurrent neural network (RNN).

Examples of a transfer-based model include generative pre-trained transformer (GPT) or bidirectional auto regressive dialogues (BARD). However, a transfer-based model is not limited to those examples. Examples of an RNN-based model include receptance weighted key value (RWKV). However, an RNN-based model is not limited to that example.

Meanwhile, it is preferable that the learning is performed in such a way that the input information is not used as a new response, so that the input individual information is kept confidential. Moreover, the generative AI can be a language model trained (for example, fine-tuned) exclusively to generate response information. The generative AI is installed in an external information processing device, and the information processing device 1 uses the generative AI via an application programming interface (API). Alternatively, the generative AI can be installed in the information processing device 1.

Examples of a conversational service designed for specific use using a generative AI include a restaurant reservation service that is designed for the specific use of making reservation of a restaurant. However, the service is not limited to that example. For example, in place of or in addition to the service designed for specific use of making reservation of a restaurant, the information processing device 1 can be configured to provide a service designed for the specific use of making reservation of an accommodation, or making reservation of a trip/accommodation, or making transaction of movable asset, or making transaction of real estate, or delivering videos, or delivering news, or making recruitment.

In the terminal device 2 of the user U, a communication application is installed as an application program for sending and receiving messages among the users U or with the concerned user U. The communication application is equipped with, for example, a chat function, a calling function, and a wallet function. Moreover, the communication application can also have various other functions such as a news provision function, a taxi dispatch service, a shopping function, and a presentation function. The communication application is also called a super application.

Using the communication application, the concerned user U can implement the chat function, the calling function, and the wallet function. The chat function enables the concerned user U to send and receive messages in a chatroom of a message channel that is channel-registered with another user U or with a store S. Herein, channel registration is also called friend registration.

The calling function enables the concerned user U to make voice calls or video calls with another user U who is channel-registered. The wallet function is equipped with functions such as payment and money transfer. Thus, using the wallet function, the concerned user U can make payments at the time of purchasing products and using services.

The terminal device 2 can send information to and receive information from the information processing device 1 using a communication application via an API. Alternatively, the terminal device 2 can send information to and receive information from the information processing device 1 without using an API.

The user U operates the terminal device 2, runs the communication application, and displays an application screen representing the screen of the communication application in the terminal device 2. As a result, the user U becomes able to implement the functions of the communication application.

The application screen includes a registration list screen for indicating the list of other users U who are channel-registered and the services that are channel-registered; and includes a chat screen for enabling communication of chat messages in the chat room for the other channel-registered users U and a chat room for enabling communication of chat messages in the chat room for the channel-registered services. In the following explanation, the chat room for the channel-registered services is sometimes simply referred to as the chat room. Meanwhile, the communication application can be an application dedicated to a service designed for specific use.

The information processing device 1 can also function as a delivery device that delivers control information to the terminal device 2. The control information is written in script language such as JavaScript (registered trademark) or a stylesheet language such as (Cascading Style Sheets). Meanwhile, the communication application delivered from the information processing device 1 can itself be treated as the control information.

In the following explanation, regarding the restaurant reservation service that is a service designed for specific use as provided by the information processing device 1 and that is implemented in the form of a conversation using a generative AI, the explanation is given about an example in which the user U issues a request for searching for a restaurant and issues a request for reserving a restaurant in that order. However, that is not the only possible example.

As illustrated in FIG. 1, the information processing device 1 receives input information sent from the terminal device 2 (Step S1). The input information represents the information that is input in the chat room, which is display in the terminal device 2, as a result of the operation of the terminal device 2 by the user U. Moreover, the input information is in the form of a text. Then, the terminal device 2 sends the information, which is input by the user U in the chat room, to the information processing device 1.

In the example illustrated in (a1) in FIG. 1, the information about a character string “A friend has come over for a visit, so I am thinking of going out tonight to a restaurant for dinner. I was wondering if there is any tasty seafood restaurant nearby.” is input as the input information (input message) in the terminal device 2 by the user U. That input information is sent from the terminal device 2 to the information processing device 1.

Subsequently, the information processing device 1 inputs the information containing user input information, which represents the input information received at Step S1, to a generative AI (Step S2), and obtains output information corresponding to the user input information from the generative AI (Step S3).

For example, the information processing device 1 inputs, to the generative AI, information containing intent definition information, which is used to extract the intent type and the intent details from the user input information, and containing the user input information; and obtains, as output information from the generative AI, intent information containing the information indicating the intent type and the information indicating the intent details.

The intent type indicates, for example, the type of the intent of the input statement given in the user input information. When the restaurant reservation service represents the service designed for specific use, the intent type indicates, for example, searching for a restaurant, asking question related to a restaurant, and making a reservation of a restaurant. However, the intent type is not limited to those examples.

The intent details represents the details of the intent of the input statement given in the user input information. When the restaurant reservation service represents the service designed for specific use, if searching for a restaurant represents the intent type, then the intent details are indicated by the information enabling identification of the type of the restaurant, the location of the restaurant, the reservation date, the reservation time, and the number of people. The type of the restaurant indicates the genre of the food provided by the restaurant, such as a Japanese restaurant, a Chinese restaurant, an Italian restaurant, a French restaurant, a family-style restaurant, a seafood restaurant, or a Japanese-style bar. However, the type of the restaurant is not limited to those examples.

If asking question related to a restaurant represents the intent type, then the intent details are indicated by the information enabling identification of the restaurant (for example, a restaurant ID (Identifier)). If making a reservation of a restaurant represents the intent type, then the intent details are indicated by the information enabling identification of the restaurant (for example, the restaurant ID), the reservation date, the reservation time, and the reserved-seat count.

The intent definition information contains, for example, instruction information containing an instruction for extracting the intent type and the intent details from the user input information, and definition information containing the intent type and information for defining the intent type. The instruction information indicates the following character string, for example: “You are a professional operator of the restaurant reservation service. From among the intent types given below, determine the intent type of the input statement and output that intent type along with the intent details. If the intent type of the input statement is not included in the intent types given below, output that the intent type is not available.”. However, the instruction information is not limited to that example.

When searching for a restaurant represents the intent type, the definition information indicates the following character string, for example: “intent type: searching for a restaurant\nintent details: type of restaurant, location of restaurant, reservation date, reservation time, and number of people\nexample of output format: intent type: searching for a restaurant\ntype of restaurant: seafood restaurant \nlocation of restaurant: Akasaka\nreservation date: Oct. 16/2023\nreservation time: 18:00\nnumber of people: 2”. However, the definition information is not limited to that example.

As a result, the information processing device 1 becomes able to obtain the intent information, which contains the information indicating the intent type and the information indicating the intent details, as the output information from the generative AI, and to appropriately generate the response information corresponding to the user information using the output information.

Alternatively, the information processing device can use a generative AI that is trained to output the intent information as the output information in response to the input of the information containing the user information and the definition information. In the definition information, each of a variety of functions executable in the information processing device 1 is defined. In this case, from the generative AI, the information processing device 1 obtains, as the output information corresponding to the user input information, information containing the information that enables identification of the function corresponding to the intent type and the information that indicates the arguments of the function corresponding to the intent type. In the following explanation, it is assumed that the information processing device 1 uses the definition information, in which each of a plurality of functions is defined, and obtains the output information corresponding to the user input information.

When the restaurant reservation service represents the service designed for specific use, the plurality of functions include, for example, a function related to searching, a function related to questioning, and a function related to reservation. The function related to searching makes use of a search API provided by a search server that searches for the restaurants. The function related to questioning makes use of a function using the search API and a function using the generative AI. The function related to reservation makes use of a reservation API provided by a reservation server that makes a reservation of a restaurant.

Meanwhile, the information processing device 1 can also make use of a generative AI that is trained to output, as the intent information, function identification information that contains information indicating the function to be used in generating the response information from among a plurality of functions and indicating the arguments of that particular function. In that case, the information processing device 1 inputs the user information to the generative AI, but does not input the definition information to the generative AI.

The arguments of the function related to searching represent, for example, information such as the type of the restaurant, the location of the restaurant, the reservation date, the reservation time, and the number of people. However, the arguments of the function related to searching are not limited to that example. The arguments of the function related to questioning represent, for example, information such as the restaurant ID and the search target. However, the arguments of the function related to questioning are not limited to that example. The arguments of the function related to reservation represent information such as the restaurant ID, the reservation date, the reservation time, and the reserved-seat count. However, the arguments of the function related to reservation are not limited to that example.

When the character string “A friend has come over for a visit, so I am thinking of going out tonight to a restaurant for dinner. I was wondering if there is any tasty seafood restaurant nearby.” is input as the user input information along the function information to the generative AI; the function identification information that contains the information enabling identification of the function related to searching is output as the intent information from the generative AI.

In that case, the function identification information not only contains the information enabling identification of the function related to searching but also contains the following information as the information about the arguments of the function related to searching: information about the character string “seafood restaurant” as the information indicating the type of the restaurant; information about the character string “the location of the user” as the information indicating the location of the restaurant; information about the character string “Oct. 16, 2023” as the information indicating the reservation date; and information about the character string “18:00” as the information indicating the reservation time. The information about those arguments represents the information indicating the intent details, and also represents search condition information indicating the search conditions.

Based on the output information obtained at Step S3, the information processing device 1 generates dialogue data as the information for conducting a dialogue with the user U (Step S4). The dialogue data is data to which, for example, the dialogue history of the past dialogue with the user U, the variable information about the user U, and the information indicating specific events is added. The dialogue data is generated in, for example, the units of dialogues conducted with the user U. A unit of dialogue represents the unit separated by the period of time from the start of a dialogue with the user U to the end of that dialogue.

The variable information about the user U represents information indicating, for example, the location of the user U. However, the variable information about the user U is not limited to that example. The dialogue data represents information in a predetermined format and, for example, is structured information (structured data) enabling a search or analysis with ease. The structured information (structured data) is in, for example, the JSON (JavaScript Object Notation) format, but is not limited to that format.

The information indicating a specific event represents, for example, information that, when the arguments in the function identification information represent specific information, points to that specific information, and contains information indicating the event type and information indicating the event details. The information indicating the event type represents, for example, the information indicating the lack of the location of the user U.

The information indicating the information details contains, for example, information about the character string “search”, information about the character string “seafood restaurant”, and information about the character string “user location”. The information about the character string “search” indicates the intent type. The information about the character string “seafood restaurant” and the information about the character string “user location” indicates the intent details.

In the dialog data, the following information is added to the dialogue history: user dialogue history that is to be input to a generative AI as the dialogue history of the user U; and generative AI dialogue history that is to be input to the generative AI as the dialogue history of the generative AI. In the dialogue data generated at Step S4, information indicating the intent type and information indicating the intent details, which is included in the intent information obtained from the generative AI at Step S3, is included as the user dialogue history.

In the example illustrated in (b1) in FIG. 1, the information about a character string [“intent”: “search”] represents the information indicating the intent type; and the information about a character string [“query”: “seafood restaurant”], the information about a character string [“USER_LOCATION”], the information about a character string [“date”: “10162023”], and the information about a character string [“time”: “18:00”] represents the information indicating the intent details.

Moreover, in the dialogue data illustrated in (b1) in FIG. 1, a character string [lackOfUserLocation] that represents the information indicating the lack of the location of the user U is included as the information indicating the event type; and information indicating that searching represents the search type, seafood restaurant represents the restaurant type, and location of user U represents the location is included as the information indicating the details of the event.

Meanwhile, instead of including the information indicating the intent type and the information indicating the intent details, which is included in the intent information obtained from the generative AI at Step S3, in the dialogue data at Step S4; the information processing device 1 can add that information in the dialogue box at Step S9 explained later.

Since the fact that the information indicating the location of the restaurant is to be treated as the search condition information is indicated by the information about the character string “lackOfUserLocation”, the information processing device 1 sends, to the terminal device 2, inquiry information representing the information for asking the user U about whether or not the location information can be sent (Step S5). Based on the inquiry information sent from the information processing device 1, the terminal device 2 displays, in the chat room, information indicating an inquiry about the location of the restaurant.

In the example illustrated in (a1) in FIG. 1, a character string “Is it ok to obtain the present location from the terminal device?” and two buttons for asking the user U about whether or not the location information can be sent are displayed in the chat room that is displayed in the terminal device 2. The two buttons include a first button indicating the information about a character string “Yes” and a second button indicating the information about a character string “No”.

If the user U operates the terminal device 2 and selects the first button by tapping on it, the terminal device 2 implements the function of the communication application; obtains location information indicating the present location from a built-in location sensor; and sends, to the information processing device 1, first-button selection information containing the obtained location information as the location information about the user U.

The location information represents information about sensor detection information that is obtained by the information processing device 1 from the terminal device 2. However, the sensor detection information that is obtained by the information processing device 1 from the terminal device 2 is not limited to the location information and, for example, alternatively can be biological information about the user U.

The first-button selection information indicates that the user U has selected the first button and contains, as the location information about the user U, data indicating the present location of the user U in the form of the latitude and the longitude.

On the other hand, if the user U operates the terminal device 2 and selects the second button by tapping on it, the terminal device 2 sends, to the information processing device 1, second-button selection information indicating that the user U has selected the second button. In the following explanation, when the first-button selection information and the second-button selection information need not be distinguished from each other, it is simply referred to as button information.

The information processing device 1 obtains the button information sent from the terminal device 2 (Step S6). If the first-button selection information is obtained, the information processing device 1 generates a search query in which the location information, which is indicated by the first-button selection information, and information about the arguments of the function related to the search as identified by the intent information is included as the search condition information; and sends the generated search query to a search server via the search API (Step S7).

The location information included in the first-button selection information represents, for example, the information indicating the present location of the user U or the information indicating the area that includes the present location of the user U. However, the location information is not limited to that example. In the search condition information specified a search query, the following information is included, for example: the location information indicated in the first-button selection information; and the information indicating the type of the restaurant, the reservation date, and the reservation time as the information indicated by the arguments of the function related to the search as identified in the intent information.

Subsequently, the information processing device 1 obtains, from the search server via the search API, the search result corresponding to the search query (Step S8). The search result includes the information indicating one or more such restaurants which are of the type specified in the search condition information, which are located around the present location of the user U as specified in the search condition information, and which are open at the reservation date and the reservation time specified in the search condition information.

In the example illustrated in FIG. 1, the search result includes the information indicating the number of seafood restaurants that match with the condition of being open at 18:00 on Oct. 16, 2023, and includes the information indicating one or more such seafood restaurants. In the example illustrated in (a2) in FIG. 1, in the chatroom displayed in the terminal device 2, the following character string is displayed: “Found one seafood restaurant that is close to the present location and that is open at 18:00 today on Oct. 16, 2023. ⋄⋄ABC Seafood⋄⋄ Relish delicious cuisine prepared with seafood delivered directly from the fishing port!”.

Then, based on the output information obtained at Step S3, based on the location information included in the button information obtained at Step S6, and based on the search result obtained at Step S8; the information processing device 1 updates the dialogue data as the information for enabling a dialogue with the user U (Step S9).

In the dialogue data, either the intent information obtained from the generative AI as obtained at Step S3 or the information corresponding to the intent information is included as the user dialogue history. For example, the information indicating the intent type and the information indicating the intent details, which is included in the intent information obtained from the generative AI at Step S3, is included as the user dialogue history.

In the dialogue data illustrated in (b2) in FIG. 1, the information about the character string [“intent”: “search”] represents the information indicating the intent type; and the information about the character string [“query”: “seafood restaurant”], the information about the character string [“USER_LOCATION”], the information about the character string [“date”: “10162023”], and the information about the character string [“time”: “18:00”] is included in the information indicating the intent details.

In the dialogue data illustrated in (b2) in FIG. 1, the search result obtained from the search server at Step S8 or the information corresponding to the search result is included as the generative AI dialogue history. In the example illustrated in (b2) in FIG. 1, the information about the character string [“name”: “ABC Seafood”] and the information about the character string [“description”: “Relish delicious cuisine prepared with seafood delivered directly from the fishing port!”] is included in the generative AI dialogue history. Meanwhile, if the search result obtained at Step S8 includes the information about a plurality of restaurants, then the information indicating a plurality of restaurants is included in the dialogue data.

Moreover, in the dialogue data, a character string [userLocation: {“lat”: 123.456, “lon”: 987.654}] is included as the information indicating the present location of the user U. The information indicating the present location of the user U is the information identified by the button information obtained at Step S7. Thus, based on the button information obtained at Step S7, the information processing device 1 adds the information indicating the present location of the user U in the dialogue data.

Subsequently, based on the search result obtained at Step S8, the information processing device 1 generates answer information and sends the generated answer information (a response message) to the terminal device 2 (Step S10). The terminal device 2 displays the answer information, which is sent by the information processing device 1, in the chatroom.

For example, assume that the information about a character string [“id”: “r000093218”], the information about the character string [“name”: “ABC Seafood”], and the information about the character string [“description”: “Relish delicious cuisine prepared with seafood delivered directly from the fishing port!”] is included the search result obtained at Step S8. Herein, the information about the character string [“id”: “r000093218”] represents the information indicating the restaurant ID.

In that case, for example, the information processing device 1 generates, as the answer information, the information about the character string “Found one seafood restaurant that is close to the present location and that is open at 18:00 today on Oct. 16, 2023. \n\n⋄⋄ABC Seafood⋄⋄\nRelish delicious cuisine prepared with seafood delivered directly from the fishing port!”. Based on the answer information sent from the information processing device 1, the terminal device 2 displays, in the chat room, the information about the character string “Found one seafood restaurant that is close to the present location and that is open at 18:00 today on Oct. 16, 2023. ⋄⋄ABC Seafood⋄⋄ Relish delicious cuisine prepared with seafood delivered directly from the fishing port!”.

When the user U operates the terminal device 2 and inputs a text in the chat room, that information is sent as input information from the terminal device 2 to the information processing device 1. For example, as illustrated in (a2) in FIG. 1, information indicating a character string “Can a reservation be made?” is input as the input information by the user U in the terminal device 2, and that input information is sent from the terminal device 2 to the information processing device 1.

Then, the information processing device 1 receives the input information (an input message) that is sent from the terminal device (Step S11). Subsequently, the information processing device 1 generates information containing the user input information that represents the input information received at Step S11, containing the intent definition information, and the dialogue history with the user U; and inputs the generated information to the generative AI (Step S12).

The dialogue history with the user U includes the dialogue history of the user U and the dialogue history of the generative AI. At Step S12, as the dialogue history with the user U, the information processing device 1 generates user dialogue history corresponding to the intent information extracted by the generative AI from the dialogue data. For example, based on the dialogue data illustrated in (b2) in FIG. 1, the information processing device 1 generates the information about a character string “Find a seafood restaurant at 18:00 onward on Oct. 16, 2023” as the user dialogue history.

As a result, as compared to the case in which, for example, the information about the character string “A friend has come over for a visit, so I am thinking of going out tonight to a restaurant for dinner. I was wondering if there is any tasty seafood restaurant nearby.” is treated as the user dialogue history, the information processing device 1 becomes able to appropriately add the information indicating the date and time while reducing the character count.

Moreover, as the dialogue history with the user U, the information processing device 1 generates, from the dialogue data, generative AI dialogue history corresponding to the search result. For example, based on the dialogue data illustrated in (b2) in FIG. 1, the information processing device 1 generates the information about a character string “One restaurant was found. \nName: ABC Seafood\nRestaurant ID: r000093218” as the generative AI dialogue history.

In the generative AI dialogue history, information indicating the details of the restaurant such as the information about a character string “Relish delicious cuisine prepared with seafood delivered directly from the fishing port!” is not included in the generative AI dialogue history. For that reason, the information processing device 1 becomes able to appropriately reduce unnecessary information while reducing the character count of the generative AI dialogue history.

Then, the information processing device 1 obtains, from the generative AI, the output information corresponding to the user input information input to the generative AI at Step S12 (Step S13). For example, at Step S12, the information processing device 1 inputs the dialogue history with the user U, the user input information, and the intent definition information to the generative AI; and, at Step S13, the information processing device 1 obtains, as the output information from the generative AI, the intent information that contains the information indicating the intent type and the information indicating the intent content.

For example, the information indicating the intent type represents the information indicating the function related to reservation; and the information indicating the display details represents the information indicating the conditions for making reservation. In the information indicating the intent details, for example, as the information about the arguments of the function related to reservation, the information about the character string [“is”: “r000093218”] is included as the restaurant ID; the information about the character string [“Oct. 16, 2023”] is included as the information about the day of visit; and the information about the character string [“2”] is included as the information about the number of people.

The information about such arguments represents reservation condition information indicating the reservation conditions. Meanwhile, if the information indicating the number of people is not included in the function identification information, then the information processing device 1 inquires the user U for the number of people and obtains the information indicating the number of people from the terminal device 2.

Subsequently, based on the output information obtained at Step S13, the information processing device 1 generates a reservation availability query that includes the information indicating the reservation confirmation conditions, and sends the generated reservation availability query to the reservation server via the reservation API (Step S14). In the reservation availability query, for example, the information about the character string [“id”: “r000093218”] is included as the restaurant ID; the information about the character string [“Oct. 16, 2023”] is included as the information about the reservation date; the information about the character string [“18:00”] is included as the reservation time; and the information about the character string [“2”] is included as the information about the number of people.

Then, the information processing device 1 obtains reservation availability information corresponding to the reservation availability query from the reservation server via the reservation API (Step S15). For example, the reservation availability information indicates whether or not a reservation for the restaurant identified in the reservation availability query can be made under the conditions identified in the reservation availability query.

Subsequently, based on the reservation availability information obtained at Step S15, the information processing device 1 sends, as answer information (a response message) to the terminal device 2, the information indicating whether or not it is possible to make a reservation for the restaurant for which the user U had sent a reservation availability query in the user input information received at Step S11 (Step S16).

In this way, the information processing device 1 displays, in the terminal device 2, a button meant for obtaining, from the terminal device 2 of the user U, sensor detection information in the service in the form of a dialogue using a generative AI that outputs answer information in response to the input information; and receives selection of the button when selected by the user U. When the selection of the button is received, the information processing device 1 obtains sensor detection information and generates information that corresponds to the sensor detection information and that is included in the input information which is input to the generative AI. As a result, in a service in which messages are sent to and received from the user U in the form of a dialogue, the information processing device 1 becomes able to appropriately obtain the information about the user U.

Moreover, the information processing device 1 receives input information about the user U with respect to a service that is designed for specific use and that is based on the dialogue format using a generative AI which generates output information corresponding to the input information; inputs the information containing the input information to the generative AI; and obtains the output information corresponding to the input information from the generative AI. Then, the information processing device 1 obtains the information corresponding to the output information from the generative AI and, based on the information corresponding to the output information, generates answer information in response to the input information; and, based on the output information, generates user dialogue history that is to be input to the generative AI as the dialogue history of the dialogue conducted with the user U. As a result, in a service in which messages are sent to and received from the user U in the form of a dialogue, the information processing device 1 becomes able to hold down the volume of information about the dialogue history.

### 2. Configuration of Information Processing System

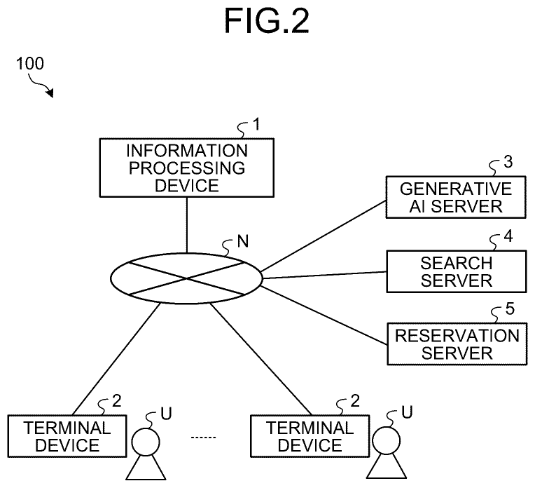

FIG. 2 is a diagram illustrating an exemplary configuration of an information processing system according to the embodiment. As illustrated in FIG. 2, an information processing system 100 according to the embodiment includes the information processing device 1, a plurality of terminal devices 2, a generative AI server 3, a search server 4, and a reservation server 5.

A plurality of terminal devices 2 is used by mutually different users U. Examples of the terminal devices 2 include a note PC (PC stands for Personal Computer), a desktop PC, a smartphone, a tablet PC, and a wearable device. Examples of a wearable device include, but are not limited to, a smart glass and a smartwatch.

The generative AI server 3 is an information processing device that inputs, to a generative AI, input information which is obtained from the information processing device via a generative AI-API representing an API dedicated to the generative AI server 3; and that provides the information processing device 1 with output information, which is output from the generative AI, via the generative AI-API. Meanwhile, the generative AI can be alternatively installed in the information processing device 1.

The search server 4 is an information processing device that searches for information in response to a search query which is obtained from the information processing device 1 via a search API representing an API dedicated to the search server 4; and that provides the information processing device 1 with the search result via the search API. Meanwhile, the functions of the search server 4 can be alternatively provided in the information processing device 1.

The reservation server 5 is an information processing device that performs processing in response to a query which is obtained from the information processing device 1 via a reservation API representing an API dedicated to the reservation server 5; and that provides the information processing device 1 with the processing result via the reservation API. Meanwhile, the functions of the reservation server 5 can be alternatively provided in the information processing device 1.

The information processing device 1, the terminal device 2, the generative AI server 3, the search server 4, and the reservation server 5 are communicably connected to each other in a wired manner or a wireless manner via a network N. Meanwhile, the information processing system 100 illustrated in FIG. 2 can include a plurality of information processing devices 1, a plurality of generative AI servers 3, a plurality of search servers 4, and a plurality of reservation servers 5.

Examples of the network N include a wide area network (WAN), such as the Internet, and a mobile communication network, such as LTE (Long Term Evolution), 4G (4th Generation), or 5G (5th Generation: the fifth generation mobile communication system).

Each terminal device 2 establishes connection with the network N via Near Field Communication such as a mobile communication network, Bluetooth (registered trademark), or a wireless LAN (Local Area Network); and becomes able to communicate with the information processing device 1, the generative AI server 3, the search server 4, and the reservation server 5.

### 3. Configuration of Information Processing Device 1

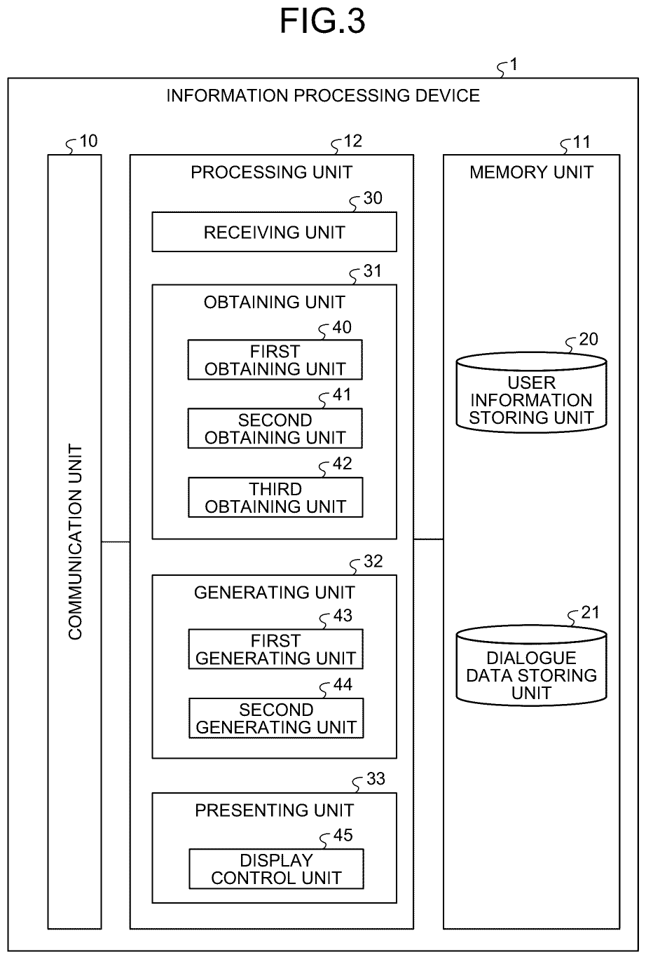

FIG. 3 is a diagram illustrating an exemplary configuration of the information processing device 1 according to the embodiment. As illustrated in FIG. 3, the information processing device 1 includes a communication unit 10, a memory unit 11, and a processing unit 12.

### [3.1. Communication Unit 10]

The communication unit 10 is implemented using, for example, a communication module or a network interface card (NIC). The communication unit 10 is connected to the network N in a wired manner or a wireless manner, and communicates information with various other devices. For example, the communication unit 10 communicates information with the terminal devices via the network N.

### [3.2. Memory Unit 11]

The memory unit 11 is implemented, for example, using a semiconductor memory device such as a random access memory (RAM) or a flash memory; or using a storage device such as a hard disk or an optical disc. The memory unit 11 includes a user information storing unit 20 and a dialogue data storing unit 21.

### [3.2.1. User Information Storing Unit 20]

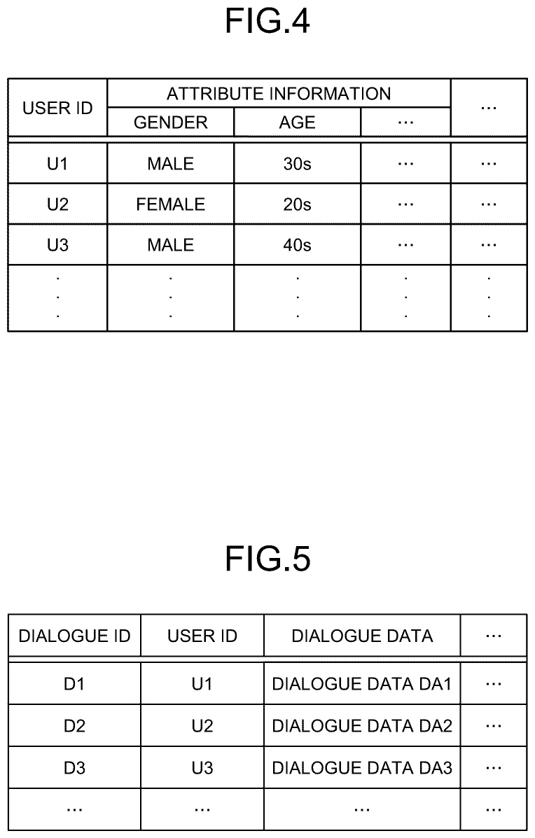

The user information storing unit 20 is used to store a variety of information related to the user U. FIG. 4 is a diagram illustrating an example of a user information table that is stored in the user information storing unit 20 of the information processing device 1 according to the embodiment.

As illustrated in FIG. 4, the user information table stored in the user information storing unit 20 includes items “user ID” and “attributed information”. The item “user ID” represents identification information enabling identification of the users U.

The item “attribute information” represents the information related to the user attributes of the users U identified in the item “user ID”. The item “attribute information” includes information about psychographic attributes and information about demographic attributes. Examples of the demographic attributes include gender, age, place of residence, and profession. Examples of the psychographic attributes include interests and concerns, lifestyle, and ideology or ideological inclination; such as travel, clothing, car, and religion.

### [3.2.2. Dialogue Data Storing Unit 21]

The dialogue data storing unit 21 is used store a variety of information related to the dialogue data. FIG. 5 is a diagram illustrating an example of a dialogue data table that is stored in the dialogue data storing unit 21 of the information processing device 1 according to the embodiment.

As illustrated in FIG. 5, the dialogue data table that is stored in the dialogue data storing unit 21 includes items “dialogue ID”, “user ID”, and “dialogue data”. The item “dialogue ID” represents identification information enabling identification of the sets of dialogue data.

The item “user ID” represents the user IDs associated to the sets of dialogue data that are identified by the item “dialogue ID”. The item “dialogue data” represents the sets of dialogue data identified by the item “dialogue ID” and includes the dialogue history of the dialogues with the users U identified by the item “user ID”. The dialogue history of the dialogue with each user U includes, for example, the dialogue history of the user U and the dialogue history of the generative AI.

The dialogue history of the user U represents the information generated as the dialogue information about the user U based on the output information extracted by the generative AI from the user input information that is the input information input by the user U; and is input to the generative AI as the dialogue history with the user U and as part of the input information.

The dialogue history of the generative AI represents the information that is generated as the dialogue information about the generative AI based on the information obtained on the basis of the output information which is output from the generative AI in response to the user input information (for example, based on the search result obtained by the search server 4 or the reservation availability information obtained by the reservation server 5); and is input to the generative AI as the dialogue history with the user U and as part of the input information.

### [3.3. Processing Unit 12]

The processing unit 12 is a controller and, for example, is implemented when a processor such as a central processing unit (CPU) or a micro processing unit (MPU) executes various computer programs (equivalent to an example of an information processing program), which are stored in the internal storage device of the information processing device 1), while using the RAM as the work area.

Alternatively, the processing unit 12 can be a controller and, for example, can be implemented using an integrated circuit such as an application specific integrated circuit (ASIC), a field programmable gate array (FPGA), or a general purpose graphic processing unit (GPGPU).

As illustrated in FIG. 3, the processing unit 12 includes a receiving unit 30, an obtaining unit 31, a generating unit 32, and a presenting unit 33; and implements or executes the functions and the actions of information processing as explained below. However, the internal configuration of the processing unit 12 is not limited to the configuration illustrated in FIG. 3. Thus, as long as the information processing explained below can be performed, the processing unit 12 can have any other configuration.

### [3.3.1. Receiving Unit 30]

The receiving unit 30 receives a variety of information sent from the terminal device 2 of the concerned user U, and thus receives various operation details such as the input of information or the selection of a button from the user U.

For example, the receiving unit 30 receives the user input information that represents the input information input by the user U with respect to a service designed for specific use based on the dialogue format using a generative AI that generates output information corresponding to the input information.

Herein, the service designed for specific use represents the restaurant reservation service in which making a reservation of a restaurant represents the specific use. However, the service designed for specific use is not limited to that example. For example, in place of or in addition to the restaurant reservation service, the service designed for the specific use can be a service of making reservation of an accommodation, or a service of making reservation of a trip/accommodation, or a service of making transaction of movable asset, or a service of making transaction of real estate, or a service of delivering videos, or a service of delivering news, or a service of making recruitment.

For example, the receiving unit 30 receives, as the input information from the use U in the chatroom displayed in the terminal device 2, the information about the character strings in a natural language as input by the user U as a dialogue in the chatroom by operating the terminal device 2.

When the information about the character strings in a natural language as input by the user U as a dialogue in the chatroom, which is displayed in the terminal device 2, by operating the terminal device 2; the terminal device 2 sends, to the information processing device 1, the information about the character strings as the input information about the user U in the chatroom.

Moreover, the receiving unit 30 receives the button information sent from the terminal device 2, and thus receives the selection of buttons made by the user U. For example, the receiving unit 30 receives the first-button selection information sent from the terminal device 2, and thus receives the selection of the first button as made by the user U; and receives the second-button selection information sent from the terminal device 2, and thus receives the selection of the second button as made by the user U.

Furthermore, the receiving unit 30 receives third-button selection information that is sent from the terminal device 2, and thus receives the selection of a third button as made by the user U; and receives fourth-button selection information sent from the terminal device 2, and thus receives the selection of a fourth button as made by the user U.

### [3.3.2. Obtaining Unit 31]

The obtaining unit 31 obtains a variety of information. The obtaining unit 31 obtains sensor detection information that is sent from the terminal device 2. The sensor detection information represents information obtained by a sensor built into the terminal device 2. The sensors built into the terminal device 2 include a location sensor, a gyro sensor, an acceleration sensor, a geomagnetic sensor, an illumination level sensor, a temperature sensor, a pneumatic sensor, and a biological sensor.

The location sensor detects, for example, the location of the terminal device 2 representing the present location of the user U. The location sensor receives a plurality of positioning signals transmitted from a plurality of positioning satellites in the global navigation satellite system (GNSS), and detects the present location of the user U based on the received positioning signals.

Examples of the biological sensor include a sensor for detecting the heart rate of the user, a sensor for detecting the pulse of the user, a sensor for detecting the blood pressure of the user, a sensor for detecting the pupillary reaction of the user, a sensor for detecting the brain waves of the user, and a sensor for detecting the blood oxygen level of the user. Meanwhile, the sensor detection information can alternatively be the information that is detected by some other terminal device other than the terminal device 2 and that is obtained by the terminal device 2.

Moreover, the obtaining unit 31 obtains a variety of information from, for example, the terminal device 2, the generative AI of the generative AI server 3, the search server 4, the reservation server 5, and the memory unit 11. The obtaining unit 31 obtains, for example, the user information that is received by the receiving unit 30.

For example, when the selection of the first button is received by the receiving unit 30, the obtaining unit 31 obtains the sensor detection information from the terminal device 2. The sensor detection information obtained by the obtaining unit 31 is, for example, the location information about the user U; the environment information indicating the surrounding brightness, the surrounding temperature, and the surrounding pressure of the user U; and the biological information about the user U.

Moreover, the obtaining unit 31 inputs, to the generative AI, the information containing the input information received from the user U; and obtains, from the generative AI, the output information corresponding to the input information. The obtaining unit 31 inputs the input information to the generative AI via the generative AI-API; and obtains the output information corresponding to the input information from the generative AI via the generative AI-API.

The generative AI is, for example, a text generative AI that, for example, a language model trained to estimate and output the subsequent token from the input token string. Examples of the generative AI include transfer-based model or an RNN-based model.

Examples of the transfer-based model include, but are not limited to, GPT and BARD. Examples of the RNN-based model include, but are not limited to, RWKV.

Regarding the input information, it is preferable that learning in done in such a way that the input information is not used as the new answer, so that the input individual information is kept secret. Meanwhile, the generative AI can be a language model trained (for example, fine-tuned) exclusively to generate answer information. The generative AI is installed in an external information processing device, and the obtaining unit 31 uses the generative AI via an API. Alternatively, the generative AI can be installed in the information processing device 1.

Moreover, the obtaining unit 31 sends a search query to the search server 4, and obtains the search result corresponding to the search query from the search server 4. For example, the obtaining unit 31 sends a search query to the search server 4 via a server API, and obtains the search result corresponding to the search query from the search server 4 via the search API.

Furthermore, the obtaining unit 31 sends a query such as a reservation availability query or a reservation query to the reservation server 5; and, from the reservation server 5, obtains the processing result corresponding to the query. For example, the obtaining unit 31 sends a search query to the reservation server 5 via the reservation API; and, from the reservation server 5 via the search API, obtains the processing result corresponding to the query.

The obtaining unit 31 includes a first obtaining unit 40, a second obtaining unit 41, and a third obtaining unit 42. In the following explanation, the specific explanation is given about each of the first obtaining unit 40, the second obtaining unit 41, and the third obtaining unit 42.

### [3.3.2.1. First Obtaining Unit 40]

The first obtaining unit 40 obtains the user input information representing the input information about the user U received by the receiving unit 30; inputs information containing the user input information to the generative AI; and obtains the output information corresponding to the user input information from the generative AI.

For example, the first obtaining unit 40 inputs, to the generative AI, information containing the intent definition information and the user input information meant for extracting the intent type and the intent details from the user input information; and obtains, as the output information from the generative AI, the intent information containing the information indicating the intent type and the information indicating the intent details.

For example, the intent type represents the type of the input of the input statement specified in the user input information. When the restaurant reservation service represents the service designed for specific use, for example, the intent type indicates, for example, searching for a restaurant, asking question related to a restaurant, and making a reservation of a restaurant. However, the intent type is not limited to those examples.

The intent details represents the details of the intent of the input statement given in the user input information. When the restaurant reservation service represents the service designed for specific use, if searching for a restaurant represents the intent type, then the intent details are indicated by the information enabling identification of the type of the restaurant, the location of the restaurant, the reservation date, the reservation time, and the number of people. The type of the restaurant indicates the genre of the food provided by the restaurant, such as a Japanese restaurant, a Chinese restaurant, an Italian restaurant, a French restaurant, a family-style restaurant, a seafood restaurant, or a Japanese-style bar. However, the type of the restaurant is not limited to those examples.

If asking question related to a restaurant represents the intent type, then the intent details are indicated by the information enabling identification of the restaurant (for example, a restaurant ID). If making a reservation of a restaurant represents the intent type, then the intent details are indicated by the information enabling identification of the restaurant (for example, the restaurant ID), the reservation date, the reservation time, and the reserved-seat count.

The intent definition information contains, for example, instruction information containing an instruction for extracting the intent type and the intent details from the user input information, and definition information containing the intent type and information for defining the intent type. The instruction information indicates the following character string, for example: “You are a professional operator of the restaurant reservation service. From among the intent types given below, determine the intent type of the input statement and output that intent type along with the intent details. If the intent type of the input statement is not included in the intent types given below, output that the intent type is not available.”. However, the instruction information is not limited to that example.

When searching for a restaurant represents the intent type, the definition information indicates the following character string, for example: “intent type: searching for a restaurant\nintent details: type of restaurant, location of restaurant, reservation date, reservation time, and number of people\nexample of output format: intent type: searching for a restaurant\ntype of restaurant: seafood restaurant\nlocation of restaurant: Akasaka\nreservation date: Oct. 16, 2023\nreservation time: 18:00\nnumber of people: 2”. However, the definition information is not limited to that example.

As a result, the first obtaining unit 40 can obtain, as the output information from the generative AI, the intent information that contains the information indicating the intent type and the information indicating the intent details; and, using the output information, becomes able to appropriately generate answer information in response to the user information.

Moreover, the first obtaining unit 40 can use a generative AI that is trained in such a way that, when information containing the user information and the definition information is input, the intent information is output as the output information. The definition information represents information in which each of a plurality of functions executable by the processing unit 12 of the information processing device 1 is defined. In that case, from the generative AI, the first obtaining unit 40 obtains, as the output information corresponding to the user input information, information containing the information that enables identification of the function corresponding to the intent type and the information that indicates the arguments of the function corresponding to the intent type.

In this way, the first obtaining unit 40 can input, to the generative AI, information that contains, as the intent definition information, the definition information in which each of a plurality of functions is defined; and can obtain, as the intent information from the generative AI, function identification information representing the information containing the information enabling identification of the function to be used in generating answer information (i.e., the function corresponding to the intent type) from among a plurality of functions and the information indicating the arguments of the concerned function.

When the restaurant reservation service represents the service designed for specific use, the plurality of functions include, for example, a function related to searching, a function related to questioning, and a function related to reservation. The function related to searching makes use of the search API provided by the search server 4 that searches for the restaurants. The function related to questioning makes use of a function using the search API and a function using the generative AI. The function related to reservation makes use of the reservation API provided by the reservation server 5 that makes a reservation of a restaurant.

Meanwhile, the first obtaining unit 40 can also a generative AI that is trained to output, as the intent information, function identification information that indicates the function to be used in generating answer information from among a plurality of functions and that indicates the arguments of the concerned function. In that case, the first obtaining unit 40 inputs the user information to the generative AI, but does not input the definition information to the generative AI.

The arguments of the function related to searching represent, for example, information such as the type of the restaurant, the location of the restaurant, the reservation date, the reservation time, and the number of people. However, the arguments of the function related to searching are not limited to that example. The arguments of the function related to questioning represent, for example, information such as the restaurant ID and the search target. However, the arguments of the function related to questioning are not limited to that example. The arguments of the function related to reservation represent information such as the restaurant ID, the reservation date, the reservation time, and the reserved-seat count. However, the arguments of the function related to reservation are not limited to that example.

When the character string “A friend has come over for a visit, so I am thinking of going out tonight to a restaurant for dinner. I was wondering if there is any tasty seafood restaurant nearby.” is input as the user input information along the function information to the generative AI; the function identification information that contains the information enabling identification of the function related to searching is output as the intent information from the generative AI.

In that case, the function identification information not only contains the information enabling identification of the function related to searching but also contains the following information as the information about the arguments of the function related to searching: information about the character string “seafood restaurant” as the information indicating the type of the restaurant; information about the character string “the location of the user” as the information indicating the location of the restaurant; information about the character string “Oct. 16, 2023” as the information indicating the reservation date; and information about the character string “18:00” as the information indicating the reservation time. The information about those arguments represents the information indicating the intent details, and also represents search condition information indicating the search conditions.

If the function corresponding to the user input information is not identifiable, the generative AI does not output the function identification information as the output information. In that case, the first obtaining unit 40 cannot obtain the function identification information from the generative AI.

The first obtaining unit 40 inputs, to the generative AI, the input information received by the receiving unit 30 and the information containing the dialogue history included in the dialogue data; and obtains the output information corresponding to the input information from the generative AI.

The dialogue history included in the dialogue data includes the user dialogue history representing the dialogue history of the user U and includes the dialogue history of the generative AI dialogue history representing the dialogue history of the generative AI. As the user dialogue history, instead of using the user input information as it is, it is possible to use some extracted part of the user input information. Moreover, as the generative AI dialogue history, instead of using the answer information for the user U as it is, it is possible to use some extract part of the answer information.

For that reason, in a service in which messages are sent to and received from the user U in the form of a dialogue, the first obtaining unit 40 becomes able to hold down the volume of information (for example, the token count) of the dialogue history to be input to the generative AI.

For example, when the character string “A friend has come over for a visit, so I am thinking of going out tonight to a restaurant for dinner. I was wondering if there is any tasty seafood restaurant nearby.” represents the input information about the user U; the information about a character string “Find a seafood restaurant at 18:00 onward on Oct. 16, 2023” is included as the user dialogue history in the dialogue data. As a result, as compared to the case in which the input information about the user U is treated as the user dialogue history, the first obtaining unit 40 becomes able to appropriately add the information indicating the date and time while reducing the character count.

When the information about the character string “One restaurant was found. \nName: ABC Seafood\nRelish delicious cuisine prepared with seafood delivered directly from the fishing port!” represents the answer information for the user U; the information about the character string “One restaurant was found. \nName: ABC Seafood\nRestaurant ID: r000093218” represents the generative AI dialogue history, and the information indicating the details of the restaurant, such as the information about the character string “Relish delicious cuisine prepared with seafood delivered directly from the fishing port!” is not included in the generative AI dialogue history. As a result, the first obtaining unit 40 becomes able to appropriately reduce unnecessary information while reducing the character count of the generative AI dialogue history.

Moreover, the first obtaining unit 40 can extract some part of the dialogue history included in the dialogue data; can input, to the generative AI, the information containing the extracted information and the input information received by the receiving unit 30; and can obtain the output information corresponding to the input information from the generative AI.

For example, when a plurality of sets of search information is included in the dialogue data, the first obtaining unit 40 extracts a new set of search information from among the plurality of sets of search information; inputs information containing that new set of search information to the generative AI; and obtains the output information corresponding to the input information from the generative AI.

In the case in which a plurality of sets of search information and question information corresponding to the latest set of search information is included in the dialogue data; the first obtaining unit 40 extracts a new set of search information from among a plurality of sets of search information, inputs information containing that new set of search information to the generative AI, and obtains the output information corresponding to the input information from the generative AI.

### [3.3.2.2. Second Obtaining Unit]

The second obtaining unit 41 obtains the information that corresponds to the output information obtained by the first obtaining unit 40. For example, the second obtaining unit 41 obtains, as the information corresponding to the output information, the information corresponding to the intent information that contains the information indicating the intent type obtained by the first obtaining unit 40 and the information indicating the intent details.

Based on the intent type obtained by the first obtaining unit 40, the second obtaining unit 41 decides on the access target; and, from the decided access target, obtains, as the information corresponding to the output information, the information corresponding to the information that indicates the intent details. The access target represents, for example, one or more servers from among a plurality of servers including the generative AI server 3, the search server 4, and the reservation server 5. However, the access target is not limited to the server, and alternatively can be, for example, the memory unit 11 or another information processing device.

For example, if the information indicating the intent type represents the information indicating the search, then the second obtaining unit 41 generates a search query based on the information indicating the intent details as obtained by the first obtaining unit 40. Then, the second obtaining unit 41 sends the generated search query to the search server 4 via the search API, and obtains the search result corresponding to the search query as the information corresponding the output information from the search server 4 via the search API.

When the sensor detection information is obtained by the third obtaining unit 42, the second obtaining unit 41 sends, to the search server 4, a search query that includes the sensor detection information as the information about the search condition, and obtains the information corresponding to the output information from the search server 4. When the sensor detection information indicates the location information about the user U, the second obtaining unit 41 sends, to the search server 4, a search query that includes the present location of the user U as the information about the search condition. Alternatively, when the sensor detection information represents biological information, the second obtaining unit 41 sends, to the search server 4, a search query that includes the biological information about the user U as the information about the search condition.

Meanwhile, for example, when the information indicating the intent type represents the information indicating a question, based on the information indicating the intent details, the second obtaining unit 41 obtains the necessary information from the search server 4 via the search API. If the information indicating the intent details is not included in the intent information, then the second obtaining unit 41 can also obtains the details information about the restaurant from the search server 4 via the search API.

When the sensor detection information is obtained by the third obtaining unit 42, the second obtaining unit 41 can send, to the search server 4, a search query that includes the sensor detection information as the information about the search condition, and can also obtain the necessary information from the search server 4.

When information is obtained from the search server 4, the second obtaining unit 41 inputs, to the generative AI, the information containing the information obtained from the search server 4 and the user input information received by the receiving unit 30; and obtains the information corresponding to the output information from the generative AI.

Meanwhile, for example, when the information indicating the intent type represents the information indicating reservation, the second obtaining unit 41 generates a query based on the information indicating the intent details obtained by the first obtaining unit 40. Then, the second obtaining unit 41 sends the generated query to the reservation server 5 via the reservation API; and, from the reservation server 5 via the reservation API, obtains the processing result corresponding to the query as the information corresponding to the output information.

### [3.3.2.3. Third Obtaining Unit 42]

When the selection of the first button is received by the receiving unit 30, the third obtaining unit 42 obtains the sensor detection information.

For example, when the selection of the first button is received by the receiving unit 30, the third obtaining unit 42 obtains the location information as the sensor detection information. The third obtaining unit 42 obtains the sensor detection information included in the first-button selection information received by the receiving unit 30. The first button is a button including the information indicating a character string “Carry out the search at the present location”. However, the first button is not limited to that example. Alternatively, for example, the first button can be a button including a character string “Allow transmission of sensor information from the terminal device, and carry out the search at the present location”.

Meanwhile, when the selection of the first button is received, in addition to or in place of obtaining the location information as the sensor detection information, the third obtaining unit 42 can obtain the biological information about the user U. In that case, for example, information indicating a character string “Allow transmission of sensor information, and carry out the search using the sensor information” is included in the first button in place of the information indicating the character string “Carry out the search at the present location”.

Meanwhile, if the sensor detection information is not included in the first-button selection information, then the third obtaining unit 42 can send a sensor detection information transmission request to the terminal device 2 for requesting transmission of the sensor detection information, and can obtain the sensor detection information that is sent from the terminal device 2 in response to the sensor detection information transmission request.

### [3.3.3. Generating Unit 32]

Based on the information obtained by the obtaining unit 31, the generating unit 32 generates answer information for the user U or generates input information to be input to a generative AI.

For example, based on the information indicating the intent type obtained by the second obtaining unit 41 of the obtaining unit 31 and based on the information corresponding to the information indicating the intent details, the generating unit 32 generates answer information for the user U.

Moreover, the generating unit 32 generates information that corresponds to the sensor detection information obtained by the obtaining unit 31 and that is included in the input information to be input to a generative AI.

The generating unit 32 includes a first generating unit 43 and a second generating unit 44. In the following explanation, the specific explanation is given about each of the first generating unit 43 and the second generating unit 44.

### [3.3.3.1. First Generating Unit 43]

Based on the information corresponding to the output information obtained by the second obtaining unit 41, the first generating unit 43 generates answer information with respect to the input information.

For example, the first generating unit 43 generates answer information based on the information that corresponds to the information indicating the intent type and the information indicating the intent details and that is obtained by the second obtaining unit 41 as the information corresponding to the output information.

For example, assume that searching represents the intent type in the information indicating the intent type, and assume that the search result obtained from the search server 4 represents the information obtained by the second obtaining unit 41 as the information corresponding to the output information. Moreover, assume that the search result includes the following information: the information about the character string “id”: “r000093218”], the information about the character string [“name”: “ABC Seafood”], and the information about the character string [“description”: “Relish delicious cuisine prepared with seafood delivered directly from the fishing port!”]. Herein, the information about the character string [“id”: “r000093218”] represents the information indicating the restaurant ID.

In that case, for example, the first generating unit 43 generates, as the answer information, the information about the character string “Found one seafood restaurant that is close to the present location and that is open at 18:00 today on Oct. 16, 2023. \n\n⋄⋄ABC Seafood⋄⋄\nRelish delicious cuisine prepared with seafood delivered directly from the fishing port!”.

Alternatively, assume that question represent the intent type in the information indicating the intent type, and assume that the information obtained by the second obtaining unit 41 from the generative AI represents the information corresponding to the output information. In that case, the first generating unit 43 generates, as answer information, information containing the information obtained from the generative AI.

For example, assume that the information obtained from the generative AI contains the information about a character string [“description”: “ABC Seafood provides superb lobster cuisine. The lobsters are sauteed with butter and garlic, and its rich flavor is surely mouth-filling. ABC Seafood would also like you to try out the steak made from fresh tuna.”].

In that case, the first generating unit 43 generates, the information about a character string [“answer”: “ABC Seafood provides superb lobster cuisine. The lobsters are sauteed with butter and garlic, and its rich flavor is surely mouth-filling. ABC Seafood would also like you to try out the steak made from fresh tuna.”] as the answer information.

Meanwhile, when the function identification information is not obtained by the first obtaining unit 40, the first generating unit 43 generates information indicating an error as the answer information. For example, the first generating unit 43 generates information indicating an error such as the information about a character string [“Regrettably not answerable because of exceeding the processing scope”] or the information about a character string [“Please input details regarding searching for a restaurant, question about a restaurant, and reservation of a restaurant”] as answer information.

For example, when GPT of OpenAI company is used as the generative AI, unless the output information about the generative AI is a response for function calling, the function identification information is not obtained by the first obtaining unit 40, the first generating unit 43 generates information indicating an error as answer information. A response for function calling includes, for example, the information about a character string [“finish_reason”: “function_call”]. Based on the information about the character string [“finish_reason”: “function_call”], the first obtaining unit 40 determines whether or not the response for function calling is present, and obtains the function identification information.

### [3.3.3.2. Second Generating Unit 44]

The second generating unit 44 generates and updates the dialogue data as the information meant for conducting a dialogue with the user U.

The dialogue data is data to which, for example, the dialogue history of the past dialogue with the user U, the variable information about the user U, and the information indicating specific events is added. The dialogue data is generated in, for example, the units of dialogues conducted with the user U. A unit of dialogue represents the unit separated by the period of time from the start of a dialogue with the user U to the end of that dialogue.

The variable information about the user U represents information indicating, for example, the location of the user U. However, the variable information about the user U is not limited to that example. The dialogue data represents information in a predetermined format and, for example, is structured information (structured data) enabling a search or analysis with ease. The structured information (structured data) is in, for example, the JSON format, but is not limited to that format.

The information indicating a specific event represents, for example, information that, when the arguments in the function identification information represent specific information, points to that specific information, and contains information indicating the event type and information indicating the event details. The information indicating the event type represents, for example, the information indicating the lack of the location of the user U.

The information indicating the event details contains, for example, the information about the character string “search”, the information about the character string “seafood restaurant”, and the information about the character string “user location”. The information about the character string “search” indicates the intent type. The information about the character string “seafood restaurant” and the information about the character string “user location” indicates the intent details.

In the dialog data, the following information is added to the dialogue history: user dialogue history that is to be input to a generative AI as the dialogue history of the user U; and generative AI dialogue history that is to be input to the generative AI as the dialogue history of the generative AI.

Based on the output information about the generative AI as obtained by the first obtaining unit 40 of the obtaining unit 31, the second generating unit 44 generates user dialogue history to be input to the generative AI as the dialogue history of the dialogue conducted with the user. The second generating unit 44 adds the generated user dialogue history to the dialogue data.

For example, based on the information indicating the intent type and the information indicating the intent details as obtained by the first obtaining unit 40, the second generating unit 44 generates the information indicating the intent type and the information indicating the intent details as the user dialogue history, and adds the user dialogue history to the dialogue data.

Moreover, based on the information corresponding to the output information obtained by the second obtaining unit 41 of the obtaining unit 31, the second generating unit 44 generates the generative AI dialogue history to be input to the generative AI as the dialogue history of the generative AI.

For example, based on the information corresponding to the information obtained by the second obtaining unit 41 of the obtaining unit 31, the second generating unit 44 generates the information indicating the intent type, the information indicating the processing target, the information indicating the intent details, and the output information about the generative AI as the generative AI dialogue history; and adds the generative AI dialogue history to the dialogue data.

In order to hold down an increase in the volume of the dialogue data, when a predetermined condition is satisfied, the second generating unit 44 deletes some part of the dialogue history included in the dialogue data. For example, when the search information is included in the dialogue data and when new search information is to be added, the second generating unit 44 deletes the old search information from the dialogue data.

For example, when the dialogue data is in the state illustrated in (b2) in FIG. 1, assume that the information a character string [“Actually, search for a yakiniku restaurant”] is sent by the terminal device 2 to the information processing device 1 as the input information from the user U. In that case, based on the input information, the generative AI outputs the information enabling identification of the function related to the search as the information indicating the intent type, and output a character string [“query”: “yakiniku restaurant”] in place of the character string [“query”: “seafood restaurant”] as the information about the argument of the concerned function.

The second obtaining unit 41 sends, to the search server 4, a search query that includes the information about the restaurant type “yakiniku” as the search condition; and obtains the search result from the search server 4. Then, based on the search intent obtained by the first obtaining unit and the search result obtained by the second obtaining unit 41, the second generating unit 44 deletes the previous search information from the dialogue data and adds the current search information to the dialogue data.

In that case, the information about a character string [“intent”: “search”, “condition”: {“query”: “seafood restaurant”, “location”: “USER_LOCATION”, “date”: “10162023”, “time”: “18:00”}, “restaurants”: “id”: “r000093218”, “name”: “ABC Seafood”, “description”: “Relish delicious cuisine prepared with seafood delivered directly from the fishing port!”] represents the previous search information that is deleted from the dialogue data.

Moreover, for example, the information about a character string [“intent”: “search”, “condition”: {“query”: “yakiniku restaurant”, “location”: “USER_LOCATION”, “date”: “10162023”, “time”: “18:00”, “restaurants”: {“id”: “r000287231”, “name”: “Hishakaku Akasaka” “description”: “All-you-can-eat yakiniku of A5 rank!”] represents the current search information that is added to the dialogue box.

Meanwhile, when the fact that the search condition has changed by or beyond the stipulated range is treated as the predetermined condition and when that predetermined condition is satisfied, all of the past search information can be deleted from the dialogue data. For example, in the case of a condition about the place, the stipulated range represents the range within a prefecture or a predetermined range. In the case of a condition about the restaurant type, the stipulated range represents the range within a genre. However, the stipulated rang is not limited to those examples.

Meanwhile, when question information is included in the dialogue data and in the case of adding new search information to the dialogue data, the second generating unit 44 can delete the past search conditions included in the dialogue data as well as delete the question information included in the dialogue data. As a result, it becomes possible to hold down an excessive increase in the data volume of the dialogue history in the dialogue data.

### [3.3.4. Presenting Unit 33]

The presenting unit 33 sends a variety of information to the terminal device 2 and thus provides the user U with a variety of information.

For example, the presenting unit 33 provides the user U with the answer information that is generated by the first generating unit 43 of the generating unit 32, and provides the user U with various buttons. The presenting unit 33 includes a display control unit 45 that displays the answer information, which is generated by the first generating unit 43, and various buttons in the chatroom.

### [3.3.4.1. Display Control Unit 45]

The display control unit 45 sends the answer information, which is generated by the first generating unit 43, to the terminal device 2; and thus displays the answer information, which is generated by the first generating unit 43, in the chatroom that is displayed in the terminal device 2.

Moreover, the display control unit 45 sends the button information to the terminal device 2; and thus displays, in the terminal device 2, the buttons enabling obtaining, from the terminal device 2, the sensor detection information representing the information detected by the sensors (not illustrated) built into the terminal device 2. Examples of the button information include the first button information and the second button information explained earlier; and examples of the buttons include the first button and the second button. In this way, the display control unit 45 can display, in the terminal device 2, the buttons that enable obtaining, from the terminal device 2 of the user U, the sensor detection information in a service that is based on the dialogue format using a generative AI which outputs answer information corresponding to the input information.

For example, based on the output information about the generative AI as obtained by the obtaining unit 31, the display control unit 45 displays a button in the terminal device 2. For example, when the output information about the generative AI as obtained by the obtaining unit 31 contains the information about a specific character string, the display control unit 45 sends the first button information to the terminal device 2 and thus displays the first button in the terminal device 2. The information about a specific character string represents, for example, the information about the character string [“USER_LOCATION”]. However, the information about a specific character string is not limited to that example.

### 4. Example of Operations Performed by Processing Unit 12

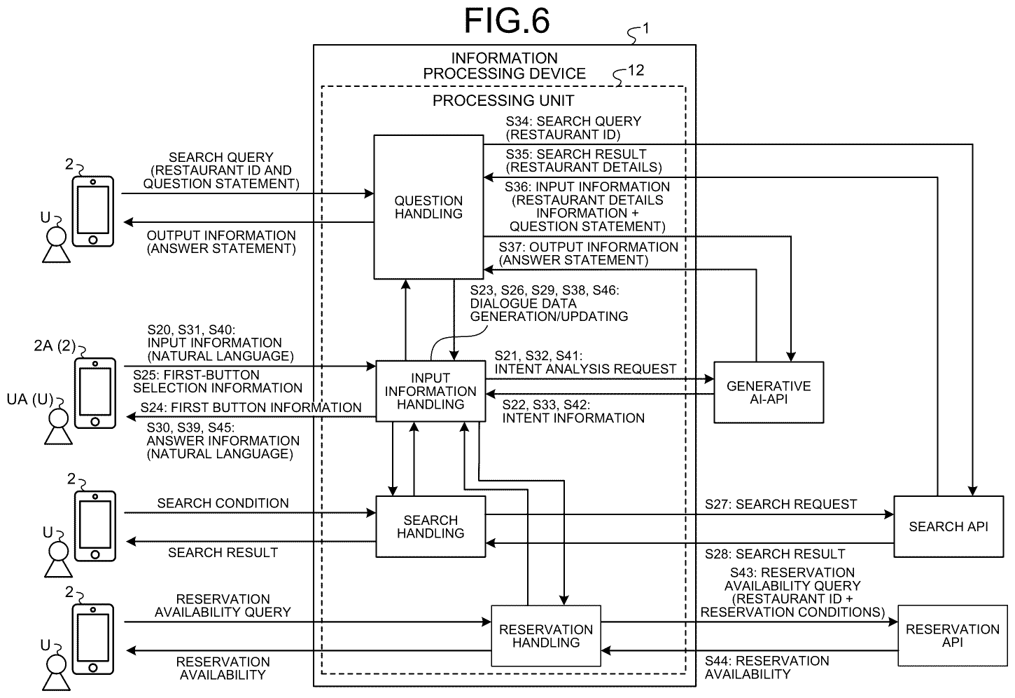

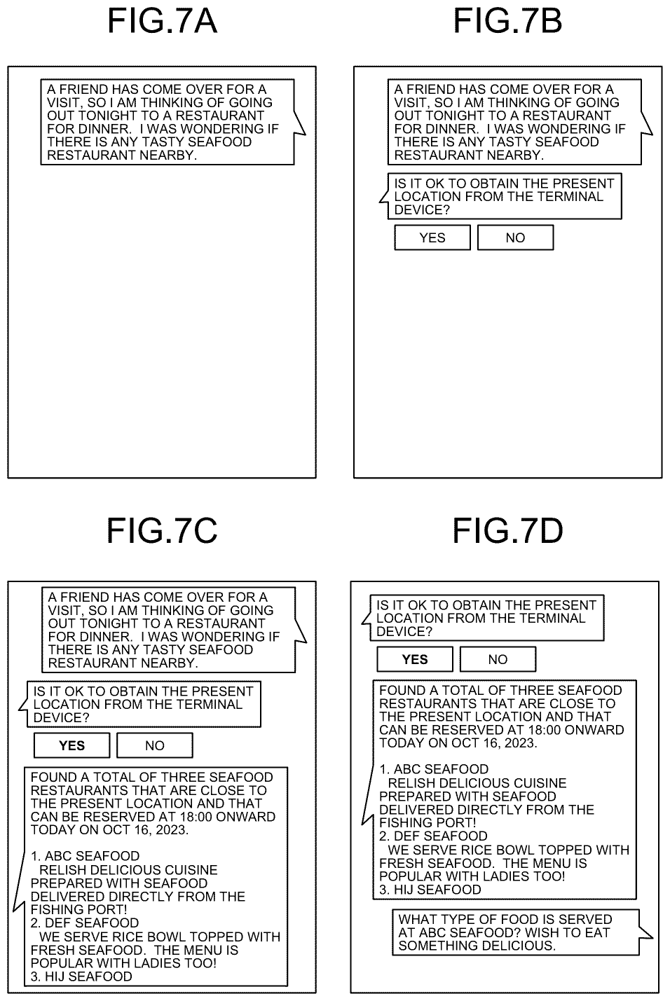

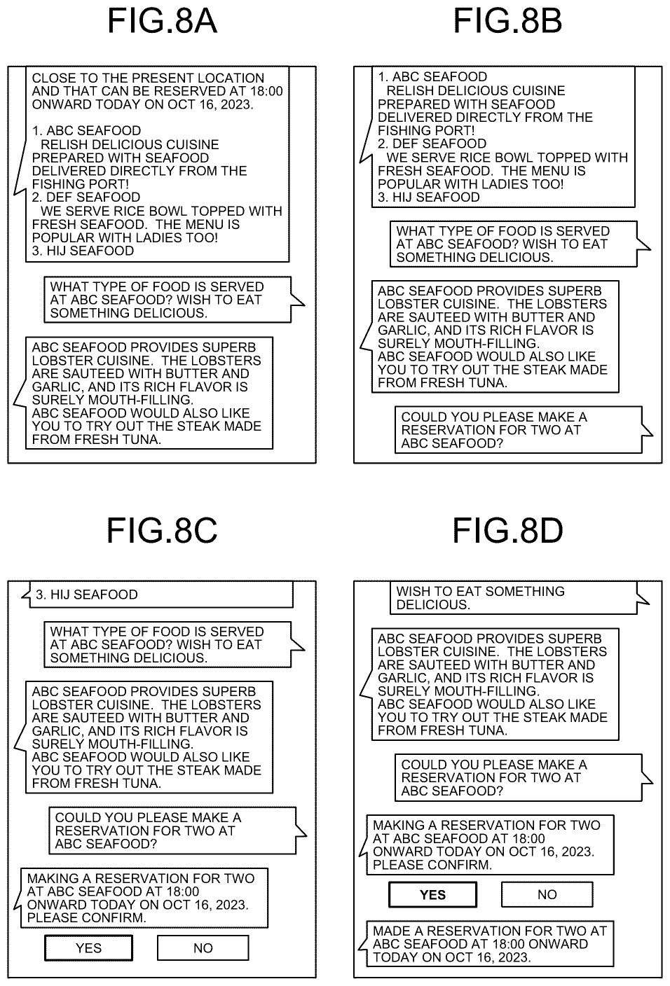

FIG. 6 is a diagram for explaining an example of the operations performed by the processing unit 12 of the information processing device 1 according to the embodiment. FIGS. 7 and 8 are diagrams illustrating an example of the information placed in the chatroom that is displayed in the terminal device 2 according to the embodiment. In FIG. 6, for explanatory convenience, one of the four terminal devices 2 is referred to as a terminal device 2A, and the user U of the terminal device 2A is referred to as a user UA.

As illustrated in FIG. 7A, when the user UA operates the terminal device 2A and inputs a character string in the chatroom; as illustrated in FIG. 6, the information about the character string as input by the user UA from the terminal device 2A is sent as the input information to the information processing device 1.

In the example illustrated in FIG. 7A, the information about the character string “A friend has come over for a visit, so I am thinking of going out tonight to a restaurant for dinner. I was wondering if there is any tasty seafood restaurant nearby.” is input as the input information to the information processing device 1.

In the processing unit 12 of the information processing device 1, the receiving unit 30 receives the input information sent from the terminal device 2A (Step S20). Then, in the obtaining unit 31 of the processing unit 12, the first obtaining unit 40 inputs, as an intent analysis request to a generative AI via a generative AI-API, information containing the input information received at Step S20 (Step S21); and obtains, as the output information from the generative AI via the generative AI-API, the intent information in response to the intent analysis request (Step S22).

For example, at Step S21, the obtaining unit 31 inputs, to the generative AI via the generative AI-API, the information containing the intent definition information, which is meant for extracting the intent type and the intent details from the input information, and the user input information. Then, at Step S22, the obtaining unit 31 obtains the intent information, which contains the information indicating the intent type and the information indicating the intent details, as the output information from the generative AI via the generative AI-API.

With reference to FIG. 6, the generative AI to which the information is input and from which the information is output via the generative AI-API is a generative AI trained in such a way that, when the information containing the user information and the definition information is input, the intent information is output as the output information. Herein, the definition information represents information for defining each of a plurality of functions.

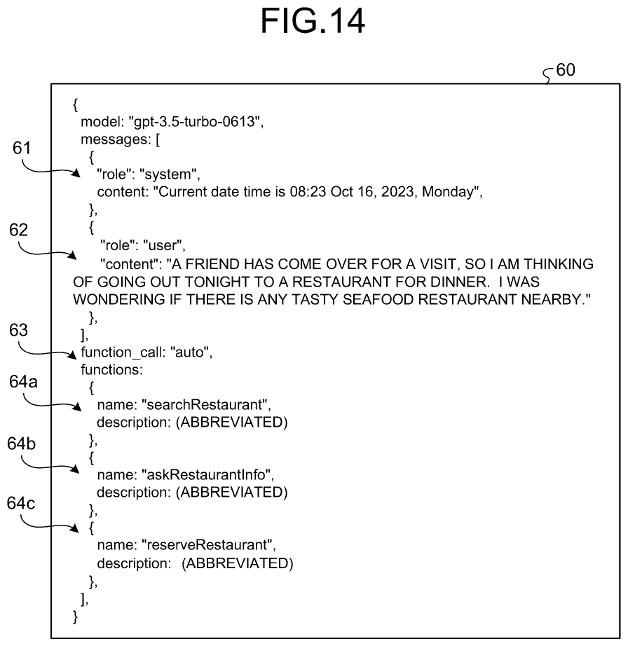

FIG. 14 is a diagram illustrating an example of the input information that is to be input to the generative AI by the obtaining unit 31 of the processing unit 12 of the information processing device 1 according to the embodiment. As illustrated in FIG. 14, input information 60 contains time-date information 61, user input information 62, function instruction information 63, and sets of function information 64a, 64b, and 64c.

In FIG. 14, the time-date information 61 represents the information indicating the current timing. The user input information 62 represents the input information about the user UA, and indicates the character string “A friend has come over for a visit, so I am thinking of going out tonight to a restaurant for dinner. I was wondering if there is any tasty seafood restaurant nearby.”

Moreover, as illustrated in FIG. 14, the function instruction information 63 represents an example in the case in which the generative AI is a large-scale language model called GPT 3.5-turbo of OpenAI company. The function instruction information 63 contains a character string [function_call: “auto”] as the information meant for outputting the function identification information from the generative AI.

Moreover, in the example illustrated in FIG. 14, the following information is also included: the function information 64a representing the information about a function related to the search as indicated by the function name ‘searchRestaurant’; the function information 64b representing the information about a function related to questioning as indicated by the function name ‘askRestaurant Info’; and the function information 64c representing the information about a function related to the reservation as indicating by the function name ‘reserveRestaurant’. In the sets of function information 64a, 64b, and 64c illustrated in FIG. 14, the information defining the specific arguments of the corresponding function is omitted as indicated by the information about a character string ‘(omitted)’.

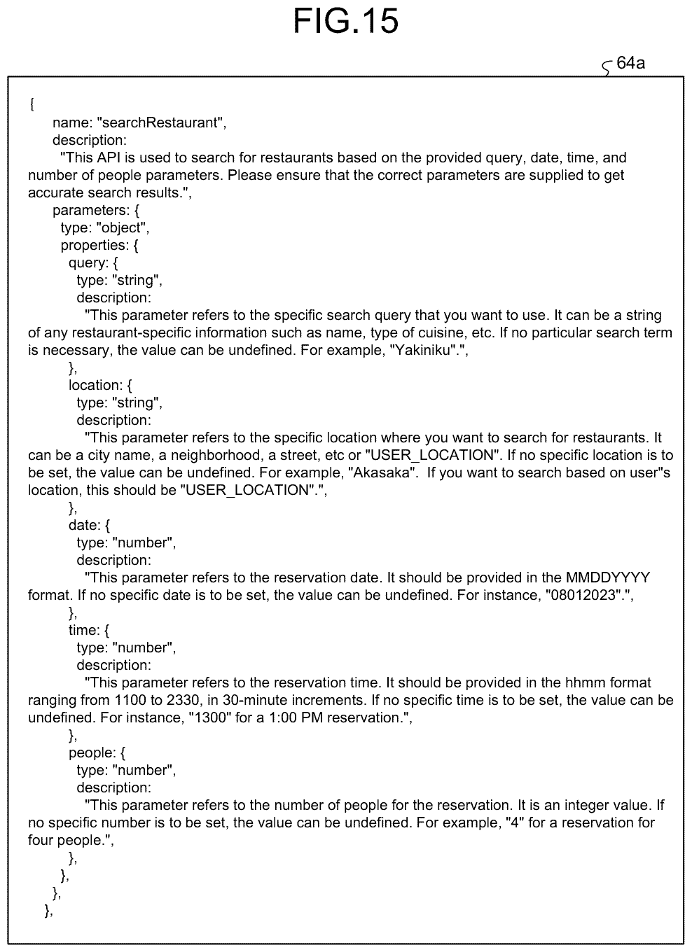

FIG. 15 is a diagram illustrating an example of the information about the function related to searching as included in the function information illustrated in FIG. 14. The function information 64a illustrated in FIG. 15 represents the information for defining the function related to the search; and the information about the character string “askRestaurantInfo” enables identification of the function name and contains the information about ‘query’ (the restaurant type), the information about ‘location’ (the location), the information about ‘date’ (the reservation date), the information about ‘time’ (the reservation time), and the information about ‘people’ (the number of people) as the information about the arguments (parameters) of the function related to the search.

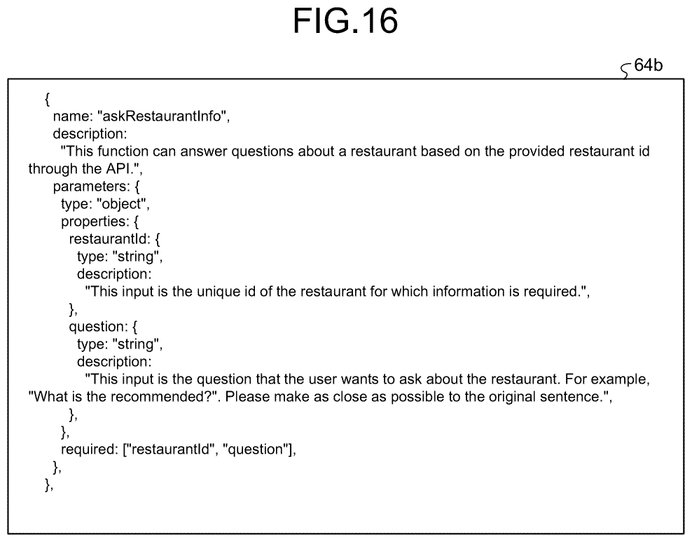

FIG. 16 is a diagram illustrating an example of the information about the function related to questioning as included in the function information illustrated in FIG. 14. The function information 64b illustrated in FIG. 16 represents the information for defining the function related to questioning; and the information about the character string ‘searchRestaurant’ enables identification of the function name and contains the information about ‘restaurantId’ (the restaurant ID) and the information about ‘question’ (the question) as the information about the arguments (parameters) of the function related to questioning.

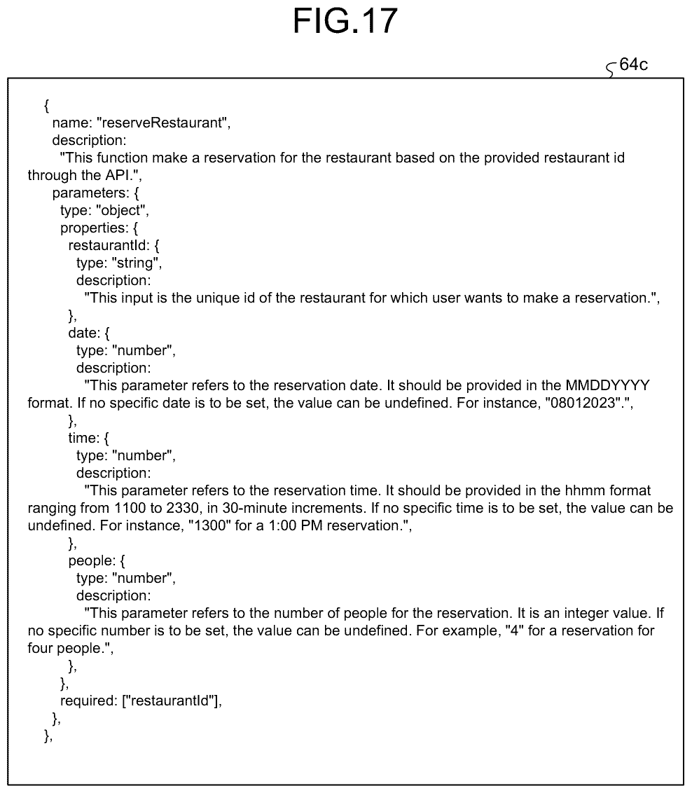

FIG. 17 is a diagram illustrating an example of the information about the function related to reservation as included in the function information illustrated in FIG. 14. The function information 64c illustrated in FIG. 17 represents the information for defining the function related to the reservation; and the information about the character string ‘reserveRestaurant’ enables identification of the function name and contains the information about ‘restaurantId’ (restaurant ID), the information about ‘date’ (the reservation date), the information about ‘time’ (the reservation time), and the information about ‘people’ (the number of people) as the information about the arguments (parameters) of the function related to the reservation.

When information about the character string “A friend has come over for a visit, so I am thinking of going out tonight to a restaurant for dinner. I was wondering if there is any tasty seafood restaurant nearby.” is sent as the input information to the information processing device 1, the generative AI outputs, as the output information, the function identification information containing the information enabling identification of the function related to the search and the information enabling identification of the arguments of the function related to the search.

Based on the output information obtained at Step S22, the information processing device 1 generates the dialogue data as the information for conducting a dialogue with the user UA (Step S23). For example, the dialogue data represents, for example, the data to which the dialogue history of the past dialogues with the user UA, the variable information about the user UA, and the information indicating a specific event is added. The dialogue data is generated in, for example, the units of dialogues conducted with the user UA. A unit of dialogue represents the unit separated by the period of time from the start of a dialogue with the user UA to the end of that dialogue.

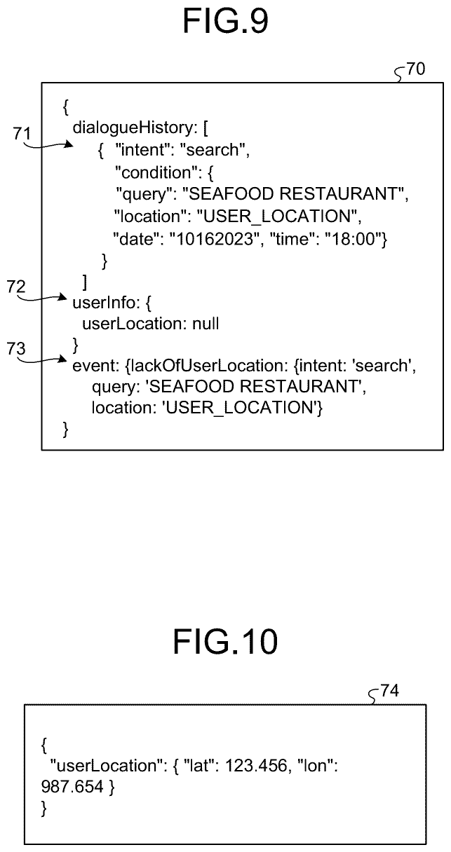

FIG. 9 is a diagram illustrating an example of the dialogue data that is generated by the generating unit 32 of the processing unit 12 of the information processing device 1 according to the embodiment. As illustrated in FIG. 9, dialogue data 70 includes search information 71, user variable information 72, and event information 73.

The search information 71 represents the information about the function related to searching, and contains the information indicating the intent type and the information indicating the intent details. In the search information 71, the information about the character string [“intent”: “search”] is included as the information indicating the intent type; and the information about the character string [“query”: “seafood restaurant”], the information about the character string [“USER_LOCATION”], the information about the character string [“date”: “10162023”], and the information about the character string [“time”: “18:00”] is included in the information indicating the intent details.

The user variable information 72 contains the information indicating the fact that the location of the user UA is not set. In the event information 73 contains, the character string [lackOfUserLocation] that represents the information indicating the lack of the location of the user UA is included as the information indicating the event type; and the information indicating that searching represents the search type, seafood restaurant represents the restaurant type, and location of user UA represents the location is included as the information indicating the details of the event.

Subsequently, when the information indicating the lack of the location of the user UA is included as the event information 73 in the dialogue data 70, the display control unit 45 of the presenting unit 33 of the processing unit 12 sends the first button information to the terminal device 2A so that the first button is displayed in the chatroom being displayed in the terminal device 2A (Step S24).

In the example illustrated in FIG. 7B, in the chatroom, the information about the character string “Is it ok to obtain the present location from the terminal device?” is displayed along with the first button indicating the information about the character string “Yes” and the second button indicating the information about the character string “No”.

When the user UA operates the terminal device 2A and selecting the first button by tapping on it, the terminal device 2A implements the function of a communication application and obtains the location information representing the data indicating the present location from the built-in location sensor, and sends the first-button selection information, which contains the obtained location information as the location information about the user UA, to the information processing device 1.

The first-button selection information represents the information indicating that the first button has been selected by the user UA and contains, as the location information about the user UA, data indicating the latitude and the longitude of the present location of the user UA. However, the location information about the user UA need not be included in the first-button selection information. In that case, in view of the selection of the first button, the third obtaining unit 42 requests the terminal device 2A to send the location information.

Meanwhile, if the user UA operates the terminal device 2A and selects the second button by tapping on it, the terminal device 2A sends, to the information processing device 1, the second-button selection information indicating that the second button has been selected by the user UA.

In the processing unit 12, the third obtaining unit 42 of the obtaining unit 31 obtains the first-button selection information that is sent from the terminal device 2A (Step S25). When the first-button selection information is obtained by the third obtaining unit 42, the second generating unit 44 of the generating unit 32 of the processing unit 12 updates the dialogue data 70 based on the location information specified in the first-button selection information (Step S26).

FIG. 10 is a diagram illustrating an example of the location information that is added as the variable information about the user UA in the dialogue data 70 by the generating unit 32 of the processing unit 12 of the information processing device 1 according to the embodiment. In the example illustrated in FIG. 10, the information about a character string [“userLocation”: {“lat”: 123.456, “lon”: 987.654}] is included as location information 74 added to the dialogue data 70.

Moreover, in the case of adding the location information 74 to the dialogue data 70, the information indicating the lack of the location of the user UA (for example, the event information 73 illustrated in FIG. 9) is deleted from the dialogue data 70. The location information 74 represents an example of the user variable information. As a result, the second generating unit 44 becomes able to reduce the data volume of the dialogue data 70.

The first generating unit 43 of the generating unit 32 generates a search query in which the location information indicated by the first-button selection information, which is received by the receiving unit 30, and the information indicating the intent details, which are specified in the output information obtained at Step S22, is included as the search condition information. Then, the second obtaining unit 41 of the obtaining unit 31 of the processing unit 12 sends the search query, which is generated by the first generating unit 43, to the search server 4 via the search API (Step S27).

Since the function identified in the function identification information, which is obtained by the first obtaining unit 40 at Step S22, is the function related to the search; at Step S27, the second obtaining unit 41 sends, to the search server 4 via the search API, a search query that includes, as the information about the search condition, the information about the arguments included in the function identification information obtained by the first obtaining unit 40 and the location information specified in the first-button selection information.

The second obtaining unit 41 obtains the search result, which corresponds to the search query, from the search server 4 via the search API (Step S28). Then, based on the search result obtained by the second obtaining unit 41 at Step S28, the second generating unit 44 of the generating unit 32 of the processing unit 12 updates the dialogue data 70 (Step S29).

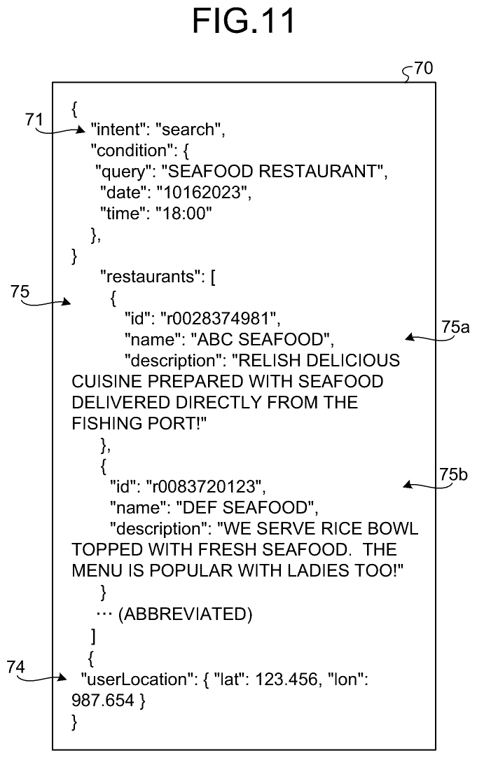

FIG. 11 is a diagram illustrating an example of the dialogue data 70 that has been updated by the generating unit 32 of the processing unit 12 of the information processing device 1 according to the embodiment. The dialogue data 70 illustrated in FIG. 11 includes the search information 71 placed at Step S23, the location information 74 added at Step S26, and a search result 75 added at Step S29.

The search result 75 illustrated in FIG. 11 includes a plurality of sets of restaurant information 75a and 75b. The restaurant information 75a contains the information about a character string [“id”: “r0028374981”] (the restaurant ID), the information about the character string [“name”: “ABC Seafood”] (the restaurant name), and the information about the character string [“description”: “Relish delicious cuisine prepared with seafood delivered directly from the fishing port!”] (the details of the restaurant).

The restaurant information 75b contains the information about a character string [“id”: “r0083720123”] (the restaurant ID), the information about a character string [“name”: “DEF Seafood”] (the restaurant name), and the information about a character string [“We serve rice bowl topped with fresh seafood. The menu is very popular with ladies too!”] (the details of the restaurant). In the search result 75 illustrated in FIG. 11, the restaurant information about the third restaurant onward is not illustrated.

Meanwhile, at Step S29, the second generating unit 44 can generate the dialogue data 70 by clubbing the operation performed at Step S23 and the operation performed at Step S26.

Subsequently, based on the search result obtained by the second obtaining unit 41 at Step S23, the first generating unit 43 of the generating unit 32 of the processing unit 12 generates answer information; and the display control unit 45 of the presenting unit 33 of the processing unit 12 displays the answer information, which is generated by the first generating unit 43, in the terminal device 2A of the user UA (Step S30).

The terminal device 2A receives the answer information sent by the display control unit 45 and displays the answer information. In the example illustrated in FIG. 7C, in the chatroom being displayed in the terminal device 2A, the information about a character string [“Found a total of three seafood restaurants that is close to the present location and that can be reserved at 18:00 onward today on Oct. 16, 2023. 1. ABC Seafood\nRelish delicious cuisine prepared with seafood delivered directly from the fishing port! 2. DEF Seafood\nWe serve rice bowl topped with fresh seafood. The menu is very popular with ladies too! 3. HIJ Seafood . . . ”] is displayed as the answer information.

As illustrated in FIG. 7D, when the user UA operates the terminal device 2A and inputs a character string in the chatroom; as illustrated in FIG. 6, the character string input by the user UA is sent as the input information from the terminal device 2A to the information processing device 1. In the example illustrated in FIG. 7D, the information about a character string [“What type of food is served at ABC\nSeafood? Wish to eat something delicious.”] is sent as the input information to the information processing device 1.

In the information processing device 1, the receiving unit 30 of the processing unit 12 receives the input information sent from the terminal device 2A (Step S31). Then, the first obtaining unit 40 of the obtaining unit 31 of the processing unit 12 inputs, as an intent analysis request to the generative AI via the generative AI-API, the information containing the input information received at Step S31 (Step S32).

For example, at Step S32, the first obtaining unit 40 inputs, to the generative AI via the generative AI-API, the information containing the intent definition information, which is meant for extracting the intent type and the intent details from the input information, and the user input information. Then, at Step S33, the obtaining unit 31 outputs, as the output information from the generative AI via the generative AI-API, the intent information containing the information indicating the intent type and the information indicating the intent details.

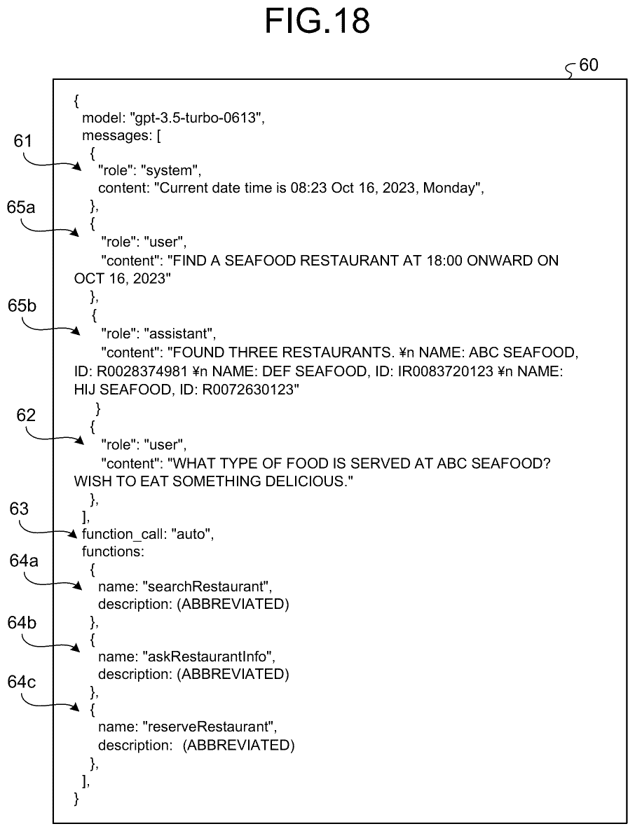

FIG. 18 is a diagram illustrating another example of the input information that is to be input to the generative AI by the obtaining unit 31 of the processing unit 12 of the information processing device 1 according to the embodiment. As illustrated in FIG. 18, the input information 60 contains time-date information 61, user input information 62, function instruction information 63, sets of function information 64a, 64b, and 64c, and dialogue histories 65a and 65b.

In FIG. 18, the user input information 62 represents the information about the character string [“What type of food is served at ABC Seafood? Wish to eat something delicious.”], and is received as the input information by the receiving unit 30 at Step S31.

The dialogue history 65a represents the user dialogue history and, in the example illustrated in FIG. 18, represents the information about the character string “Find a seafood restaurant that can be reserved at 18:00 onward on Oct. 16, 2023”. The first generating unit 43 generates the dialogue history 65a as the user dialogue history based on the search information 71 included in the dialogue data 70 illustrated in FIG. 11.

As a result, as compared to the case in which the information about the character string “A friend has come over for a visit, so I am thinking of going out tonight to a restaurant for dinner. I was wondering if there is any tasty seafood restaurant nearby.”, the second generating unit 44 becomes able to appropriately add the information indicating the date and time while reducing the character count.

The dialogue history 65b represents the generative AI dialogue history and, in the example illustrated in FIG. 18, represents the information about a character string “Found three restaurants. \nName: ABC Seafood, ID: r0028374981\nName: DEF Seafood, ID: Ir0083720123\nName: HIJ Seafood, ID: r0072630123”. The first generating unit 43 generates the dialogue history 65b as the generative AI dialogue history based on the search result 75 included in the dialogue data 70 illustrated in FIG. 11.

As a result, instead of treating the intent information, which is generated by the generative AI, as the generative AI dialogue history, the second generating unit 44 treats the search result corresponding to the intent information as the generative AI dialogue history. Thus, as compared to the case in which intent information is treated as the generative AI dialogue history, the dialogue history of the dialogues with the user can be set to appropriately details. Moreover, the explanation of the restaurant that is included in the answer information for the user UA is not specified in the generative AI dialogue history. Hence, as compared to the case in which the answer information for the user UA is treated as the generative AI dialogue history, the second generating unit 44 becomes able to reduce the volume of information about the generative AI dialogue history.

The second obtaining unit 41 of the obtaining unit 31 obtains the intent information regarding the intent analysis request as the output information from the generative AI via the generative AI-API (Step S33). The intent information obtained at Step S33 contains the information indicating the intent type and the information indicating the intent details.

The information indicating the intent type as included in the intent information output from the generative AI represents the information indicating the function related to questioning; and the information indicating the intent details contains the information about the restaurant ID enabling identification of the restaurant. The second obtaining unit 41 generates a search query that includes the restaurant ID as the search condition information and the is to be used in searching for the detailed information about the restaurant identified by the restaurant ID; and sends the search query to the search server 4 via the search API (Step S34).

Then, the second obtaining unit 41 obtains the search result corresponding to the search query from the search server 4 via the search API (Step S35). The search result includes, for example, the detailed information about the restaurant that is identified by the restaurant ID specified in the search query.

Subsequently, based on the dialogue data, based on the user input information received by the receiving unit 30 at Step S31, and based on the search result obtained at Step S35; the second obtaining unit 41 generates the input information to be input to the generative AI, and inputs the input information to the generative AI via the generative AI-API (Step S36).

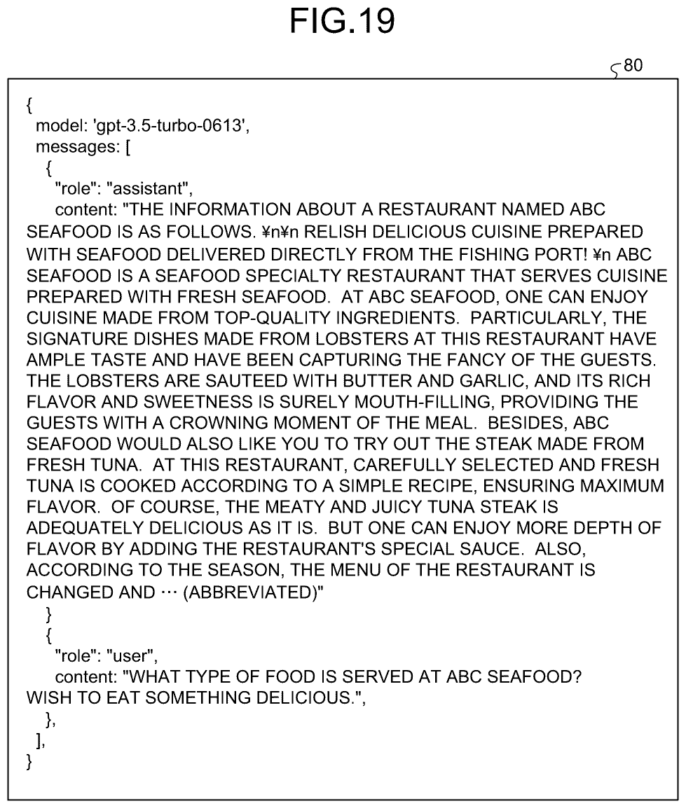

FIG. 19 is a diagram illustrating still another example of the input information that is to be input to the generative AI by the obtaining unit 31 of the processing unit 12 of the information processing device 1 according to the embodiment. In input information 80 illustrated in FIG. 19, the information about a character string “The information about a restaurant named ABC Seafood is as follows. \n\nRelish delicious cuisine prepared with seafood delivered directly from the fishing port!” is generated based on the dialogue data.

Moreover, in FIG. 19, the information about a character string “ABC Seafood is a seafood specialty restaurant that serves cuisine prepared with fresh seafood . . . . ” represents the search result obtained at Step S35. In FIG. 19, the information about the character string “What type of food is served at ABC Seafood? Wish to eat something delicious.” Represents the user input information received by the receiving unit 30 at Step S31.

The second obtaining unit 41 obtains the output information corresponding to the input information from the generative AI via the generative AI-API (Step S37). Then, based on the input information received by the receiving unit 30 at Step S31, based on the search result obtained by the second obtaining unit 41 at Step S35, and based on the output information about the generative AI as obtained by the second obtaining unit 41 at Step S37; the second generating unit 44 of the generating unit 32 updates the dialogue data 70 (Step S38).

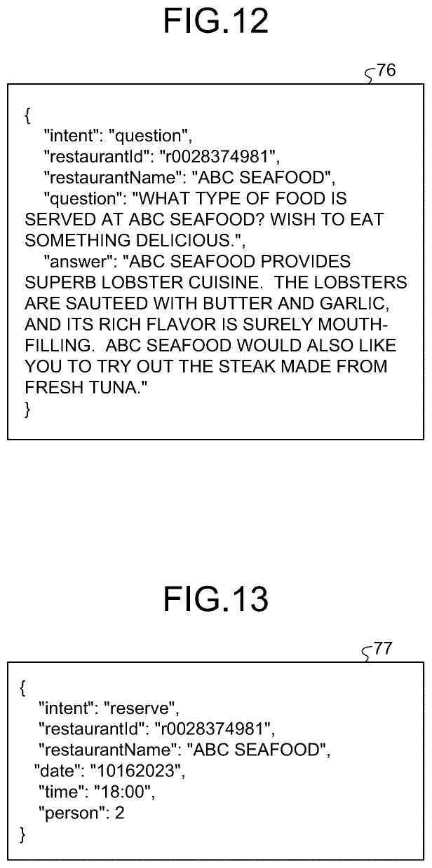

FIG. 12 is a diagram illustrating an example of the dialogue history that is added to the dialogue data 70 by the generating unit 32 of the processing unit 12 of the information processing device 1 according to the embodiment. In a dialogue history 76 illustrated in FIG. 12, the information about the character string [“intent”: “question”] is included as the information indicating the intent type; the information about the character string [“restaurantID”: “r0028374981”] is included as the information indicating the restaurant ID; the information about the character string [“restaurantName”: “ABC Seafood”] is included as the information indicating the restaurant name; and the information about the character string [“What type of food is served at ABC Seafood? Wish to eat something delicious.”] is included as the user dialogue history. Herein, the user dialogue history represents the input information received by the receiving unit 30 at Step S31.

In the dialogue history 76 illustrated in FIG. 12, the information about the character string [“ABC Seafood provides superb lobster cuisine. The lobsters are sauteed with butter and garlic, and its rich flavor is surely mouth-filling. ABC Seafood would also like you to try out the steak made from fresh tuna.”] is included as the AI dialogue history. Herein, the AI dialogue history represents the output information about the generative AI as obtained by the second obtaining unit 41 at Step S37.

Subsequently, based on the output information about the generative AI as obtained by the second obtaining unit 37 at Step S37, the first generating unit 43 of the generating unit 32 of the processing unit 12 generates answer information; and the display control unit 45 of the presenting unit 33 of the processing unit 12 displays the answer information, which is generated by the first generating unit 43, in the terminal device 2A of the user UA (Step S39).

The terminal device 2A receives the answer information sent by the display control unit 45, and displays the answer information. In the example illustrated in FIG. 8A, the information about the character string [“ABC Seafood provides superb lobster cuisine. The lobsters are sauteed with butter and garlic, and its rich flavor is surely mouth-filling. ABC Seafood would also like you to try out the steak made from fresh tuna.”] is displayed as the answer information in the chatroom being displayed in the terminal device 2A.

As illustrated in FIG. 8B, when the user UA operates the terminal device 2A and inputs the character string in the chatroom; as illustrated in FIG. 6, the information about the character string input by the user UA from the terminal device 2A sent as the input information to the information processing device 1. In the example illustrated in FIG. 8B, the information about a character string “Could you please make a reservation for two at ABC Seafood?” is sent as the input information to the information processing device 1.

The receiving unit 30 of the processing unit 12 receives the input information sent from the terminal device 2A (Step S40). The first obtaining unit 40 of the obtaining unit 31 of the processing unit 12 inputs, as an intent analysis request to the generative AI via the generative AI-API, the information containing the input information received at Step S31 (Step S41).

For example, at Step S40, the first obtaining unit 40 inputs, to the generative AI via the generative AI-API, the information containing the intent definition information, which is meant for extracting the intent type and the intent details from the input information, and the user input information. Then, at Step S41, the obtaining unit 31 obtains the intent information, which contains the information indicating the intent type and the information indicating the intent details, as the output information from the generative AI via the generative AI-API.

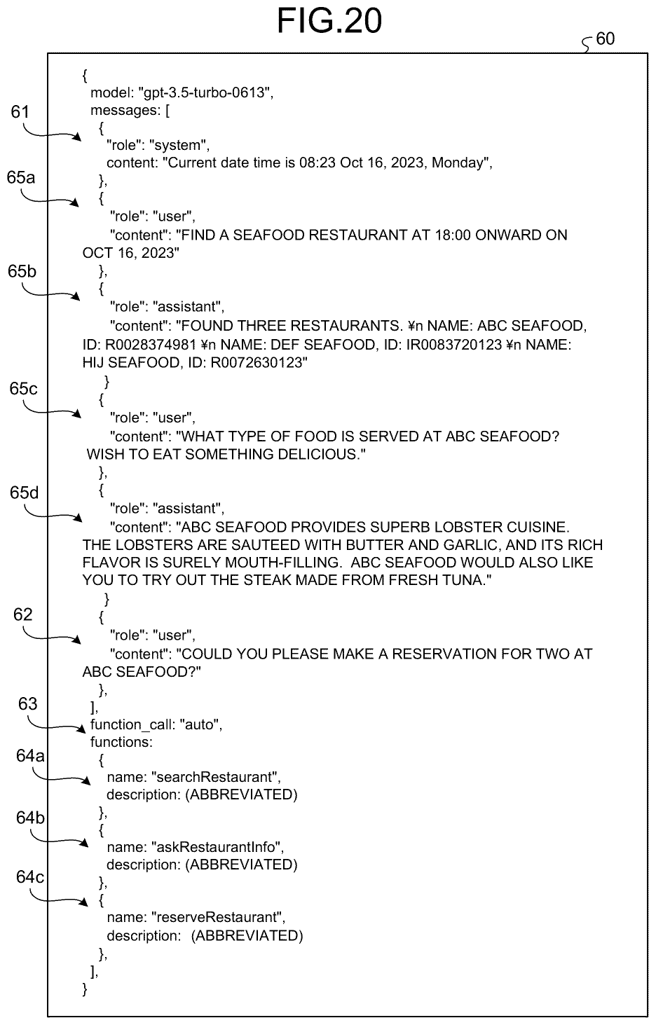

FIG. 20 is a diagram illustrating a different example of the input information that is to be input to the generative AI by the obtaining unit 31 of the processing unit 12 of the information processing device 1 according to the embodiment. As illustrated in FIG. 20, the input information 60 contains the time-date information 61, the user input information 62, the function instruction information 63, the sets of function information 64a, 64b, and 64c, and dialogue histories 65a, 65b, 65c, and 65d.

The dialogue history 65c represents the user input information 62 illustrated in FIG. 18, and the user input information 62 is used as the user dialogue history. The dialogue history 65d represents the output information obtained by the second obtaining unit 41 at Step S37, and the output information is used as the AI dialogue history.

The second obtaining unit 41 obtains, from the generative AI via the generative AI-API, the intent information representing the output information corresponding to the input information that is to be input to the generative AI at Step S41 (Step S42). When the user input information 62 illustrated in FIG. 20 represents the user input information received by the receiving unit 30 at Step S40, the generative AI outputs, as the intent information, the function identification information that contains the information enabling identification of the function related to reservation and the information enabling identification of the arguments of the function related to reservation.

In the information indicating the intent details, for example, as the information about the arguments of the function related to reservation, the information about the character string [“id”: “r000093218”] is included as the restaurant ID; the information about the character string “Oct. 16, 2023” is included as the reservation date; the information about the character string “18:00” is included as the reservation time; and the information about the character string [“2”] is included as the number of people. The information about such arguments represents reservation condition information indicating the reservation conditions.

In the intent information obtained by the first obtaining unit 40 at Step S42, since the information indicating the intent type enables identification of the function related to reservation, the second obtaining unit 41 generates a reservation availability query that includes the reservation confirmation conditions, and sends the reservation availability query to the reservation server 5 via the reservation API (Step S43).

In the reservation availability query, for example, the information about the character string [“id”: “r000093218”] is included as the restaurant ID; the information about the character string [“Oct. 16, 2023”] is included as the information about the reservation date; the information about the character string [“18:00”] is included as the reservation time; and the information about the character string [“2”] is included as the information about the number of people.

Then, the second obtaining unit 41 obtains reservation availability information corresponding to the reservation availability query from the reservation server 5 via the reservation API (Step S44). For example, the reservation availability information indicates whether or not a reservation for the restaurant identified in the reservation availability query can be made under the conditions identified in the reservation availability query.

Subsequently, based on the reservation availability information obtained at Step S44, the display control unit 45 of the presenting unit 33 sends, as answer information to the terminal device 2A, the information indicating whether or not it is possible to make a reservation for the restaurant for which the user U had sent a reservation availability query in the user input information received at Step S40; and displays the answer information in the terminal device 2A (Step S45).

The terminal device 2A receives the answer information sent by the display control unit 45 and displays the answer information. In the example illustrated in FIG. 8C, the information about a character string “Making a reservation for two at ABC Seafood at 18:00 onward today on Oct. 16, 2023. Please confirm.” is displayed as the answer information in the chatroom being displayed in the terminal device 2A.

Moreover, as illustrated in FIG. 8C, the display control unit 45 displays, in the terminal device 2A, two buttons for asking the user UA about whether or not to confirm the reservation. The two buttons include the third button indicating the information about a character string “Yes” and the fourth button indicating the information about a character string “No”.

If the user U operates the terminal device 2A and selects the third button by tapping on it, the terminal device 2 implements the function of the communication application; obtains location information indicating the present location from a built-in location sensor; and sends, to the information processing device 1, third-button selection information containing the obtained location information as the location information about the user UA.

The third obtaining unit 42 of the obtaining unit 31 obtains the button information sent from the terminal device 2, and the second obtaining unit 41 of the obtaining unit 31 sends the information indicating the confirmation of the reservation to the reservation server 5 via the reservation API. With that, the reservation at ABC Seafood gets completed. As illustrated in FIG. 8D, the display control unit 45 displays, in the terminal device 2A, the information about a character string “Made a reservation for two at ABC Seafood at 18:00 onward today on Oct. 16, 2023.” as the information indicating the confirmation of the reservation.

When the reservation at ABC Seafood is completed, the second generating unit 44 of the generating unit 32 adds a reservation history, which indicates that the reservation at ABC Seafood is completed, to the dialogue data 70 (Step S46). Thus, the reservation history is part of the dialogue history.

FIG. 13 is a diagram illustrating an example of the reservation history that is added to the dialogue data 70 by the generating unit 32 of the processing unit 12 of the information processing device 1 according to the embodiment. As illustrated in FIG. 13, a dialogue history 77, the information about a character string [“intent”: “reserve”] is included as the information indicating the intent type; the information about the character string [“restaurantId”: “r0028374981”] is included as the information indicating the restaurant ID; the information about the character string [“restaurantName”: “ABC Seafood”] is included as the information indicating the restaurant name; the information about the character string [“date”: “10162023”] is included as the information about the reservation date; the information about the character string [“time”] “18:00”] is included as the information about the reservation time; and the information about a character string [“person”: “2”] is included as the information about the number of persons.

As explained above, apart from the answer information regarding a question about a store, the answer information for the user U is generated not by the generative AI but by the generating unit 32 of the information processing device 1. Hence, for example, the information processing device 1 neither includes nonexistent stores in the search result nor gives an answer that reservation is made in spite of not making any reservation. Hence, the information processing device 1 can be operated while preventing the hallucination problem specific to a generative AI.

### 5. Flow of Operations

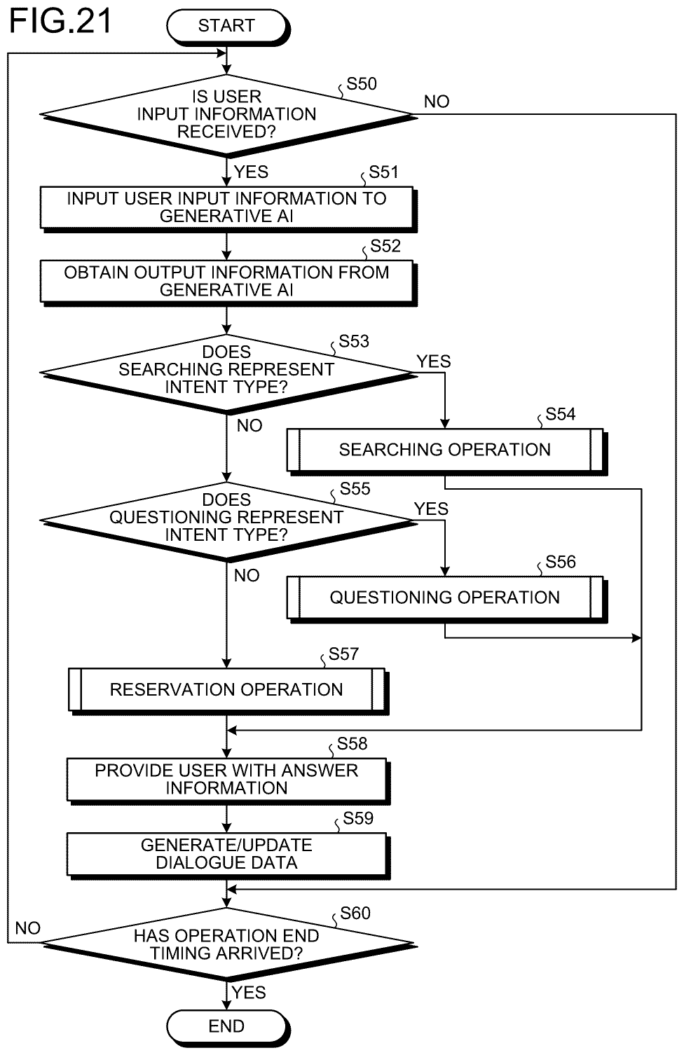

Given below is the explanation of the flow of the information processing performed by the processing unit 12 of the information processing device 1 according to the embodiment. FIG. 21 is a flowchart for explaining an example of the information processing performed by the processing unit 12 of the information processing device 1 according to the embodiment.

As illustrated in FIG. 21, the processing unit 12 of the information processing device 1 determines whether or not the user input information, which represents the input information sent from the terminal device 2, is received (Step S50). If it is determined that the user input information is received (Yes at Step S50), the processing unit 12 inputs the user input information to the generative AI (Step S51) and obtains the output information corresponding to the user input information from the generative AI (Step S52).

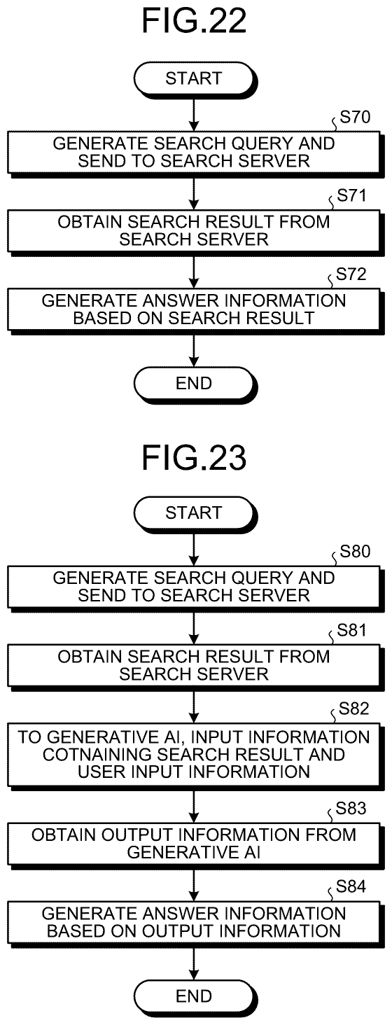

The processing unit 12 determines whether or not searching represents the intent type specified in the output information that is obtained at Step S52 (Step S53). If it is determined that searching represents the intent type (Yes at Step S53), the processing unit 12 performs a search operation (Step S54). The search operation performed at Step S54 includes operations from Step S70 to Step S72 illustrated in FIG. 22, and the detailed explanation thereof is given later.

However, if it is determined that searching does not represent the intent type (No at Step S53), the processing unit 12 determines whether or not questioning represents the intent type (Step S55). If it is determined that questioning represents the intent type (Yes at Step S55), the processing unit 12 performs a questioning operation (Step S56). The search operation performed at Step S56 includes operations from Step S80 to Step S84 illustrated in FIG. 23, and the detailed explanation thereof is given later.

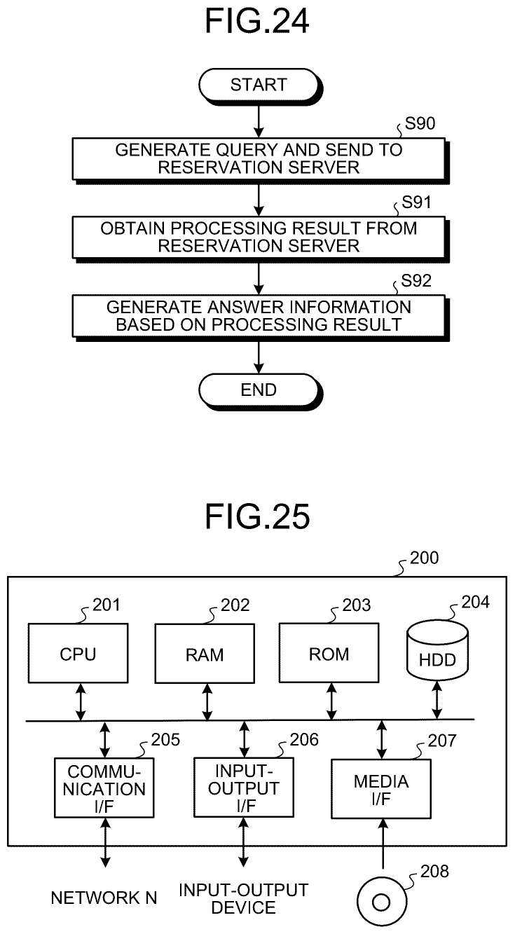

However, if it is determined that questioning does not represent the intent type (No at Step S55), the processing unit 12 determines that making a reservation represents the intent type and performs a reservation operation (Step S57). The operation performed at Step S57 includes operations from Step S90 to Step S92 illustrated in FIG. 24, and the detailed explanation thereof is given later.

When the operation at Step S54 has ended, or when the operation at Step S56 has ended, or when the operation at Step S57 has ended; the processing unit 12 provides the user U with the answer information (Step S58). Then, based on the processing result obtained at Step S54, or based on the processing result obtained at Step S56, or based on the processing result obtained at Step S57; the processing unit 12 generates or updates the dialogue data 70 (Step S59).

When the operation at Step S50 has ended or when it is determined that the user input information is not received (No at Step S50), the processing unit 12 determines whether or not the operation end timing has arrived (Step S60). For example, when the power of the information processing device 1 is switched off, the processing unit 12 determines that the operation end timing has arrived.

If it is determined that the operation end timing has not arrived (No at Step S60), the system control returns to Step S50. When it is determined that the operation end timing has arrived (Yes at Step S60), the information processing illustrated in FIG. 21 is ended.

FIG. 22 is a flowchart for explaining an example of the search operation performed by the processing unit 12 of the information processing device 1 according to the embodiment. As illustrated in FIG. 22, the processing unit 12 generates a search query based on the output information about the generative AI and sends the search query to the search server 4 (Step S70).

Then, the processing unit 12 obtains the search result corresponding to the search query from the search server 4 (Step S71) and, based on the search result, generates answer information (Step S72). It marks the end of the operations illustrated in FIG. 22.

FIG. 23 is a flowchart for explaining an example of the questioning operation performed by the processing unit 12 of the information processing device 1 according to the embodiment. As illustrated in FIG. 23, the processing unit 12 generates a search query based on the output information about the generative AI, and sends the search query to the search server 4 (Step S80).

Then, the processing unit 12 obtains the search result corresponding to the search query from the search server (Step S81). The processing unit 12 inputs, to the generative AI, the information containing the search result obtained at Step S81 and the user input information received at Step S50 (Step S82) and obtains the output information from the generative AI (Step S83). Subsequently, based on the output information obtained at Step S83, the processing unit 12 generates answer information (Step S84). It marks the end of the operations illustrated in FIG. 23.

FIG. 24 is a flowchart for explaining an example of the reservation operation performed by the processing unit 12 of the information processing device 1 according to the embodiment. As illustrated in FIG. 24, the processing unit 12 generates a query based on the output information about the generative AI, and sends the query to the reservation server 5 (Step S90).

Then, from the reservation server 5, the processing unit 12 obtains the processing result corresponding to the query (Step S91); and generates answer information based on the processing result (Step S92). It marks the end of the operations illustrated in FIG. 24.

### 6. Modification Example

In the example explained above, a text generative AI is used as an example of the generative AI. However, alternatively, the generative AI can be a multimodal generative AI.

For example, a multimodal generative AI performs text-to-voice generation, performs, performs voice-to-text generation, performs voice-to-voice generation, and performs text-to-text generation. Examples of a multimodal generative AI include, but are not limited to, GPT-4V.

Moreover, for example, the user U can make utterances with respect to the terminal device 2 and can input the utterance information as the input information to the terminal device 2. Then, the utterance information input by the user U is sent as the input information from the terminal device 2 to the information processing device 1.

When the information about the voice of an utterance made by the user U is sent as the input information from the terminal device 2, the information processing device 1 can convert the voice information into a text. Alternatively, the terminal device 2 can convert the information about the voice of an utterance made by the user U into a text, and can send that text as the input information to the information processing device 1.

### 7. Hardware Configuration

The information processing device 1 according to the embodiment described above is implemented using a computer 200 that, for example, has a configuration as illustrated in FIG. 25. FIG. 25 is a hardware configuration diagram illustrating an example of the computer 200 that implements the functions of the information processing device 1 according to the embodiment. The computer 200 includes a central processing unit (CPU) 201, a random access memory (RAM) 202, a read only memory (ROM) 203, a hard disk drive (HDD) 204, a communication interface (I/F) 205, an input-output interface (I/F) 206. And a media interface (I/F) 207.

The CPU 201 performs operations based on computer programs stored in the ROM 203 or the HDD 204, and controls the other constituent elements. The ROM 203 is used to store a boot program that is executed by the CPU 201 at the time of booting the computer 200, and to store computer programs that are dependent on the hardware of the computer 200.

The HDD 204 is used to store computer programs to be executed by the CPU 201, and to store the data used by the computer programs. The communication interface 205 receives data from other devices via the network N (see FIG. 5) and sends the data to the CPU 201; and sends the data generated by the CPU 201 to other devices via the network N.

The CPU 201 controls output devices, such as a display and a printer, and input devices, such as a keyboard or a mouse, via the input-output interface 206. The CPU 201 obtains data from an input device via the input-output interface 206. Moreover, the CPU 201 outputs the generated data to an output device via the input-output interface 206.

The media interface 207 reads computer programs or data stored in a recording medium 208, and provides the CPU 201 with read data via the RAM 202. The CPU 201 loads such computer programs from the recording medium 208 into the RAM 202 via the media interface 207, and executes the loaded computer programs. Examples of the recording medium 208 include an optical recording medium such as a digital versatile disc (DVD) or a phase change rewritable disk (PD); a magneto-optical recording medium such as a magneto-optical (MO) disk; a tape medium; a magnetic recording medium; or a semiconductor memory.

For example, when the computer 200 functions as the information processing device 1 according to the embodiment, the CPU 201 of the computer 200 executes the computer programs loaded in the RAM 202 and implements the functions of the processing unit 12. Moreover, the data in the memory unit 11 is stored in the HDD 204. Herein, the CPU 201 of the computer 200 reads the computer programs from the recording medium 208 and executes them. However, as another example, the CPU 201 can obtain the computer programs from another device via the network N.

### 8. Miscellaneous

Of the processes described above in the embodiment, all or part of the processes explained as being performed automatically can be performed manually. Similarly, all or part of the processes explained as being performed manually can be performed automatically by a known method. The processing procedures, the control procedures, specific names, various data, and information including parameters described in the embodiment or illustrated in the drawings can be changed as required unless otherwise specified. For example, a variety of information illustrated in the drawings is not limited to the illustrated information.

The constituent elements of the device illustrated in the drawings are merely conceptual, and need not be physically configured as illustrated. The constituent elements, as a whole or in part, can be separated or integrated either functionally or physically based on various types of loads or use conditions.

For example, the information processing device 1 can be implemented using a terminal device and a server computer, or can be implemented using a plurality of server computers. Alternatively, depending on the functions, the information processing device 1 can be implemented by calling an external platform using an API or network computing. Thus, the configuration of the information processing device 1 can be varied with flexibility.

Meanwhile, the embodiment and the modification example described above can be appropriately combined without causing any contradiction in the processing details.

### 9. Effect

As explained above, the information processing device 1 according to the embodiment includes the display control unit 45, the receiving unit 30, the obtaining unit 31, and the generating unit 32. The display control unit 45 displays, in the terminal device 2 of the user U, a button for obtaining the sensor detection information from the terminal device 2 in a service that is based on the dialogue format using a generative AI that generates output information corresponding to the input information. The receiving unit 30 receives the selection of the button as made by the user U. When the receiving unit 30 receives the selection of the button, the obtaining unit 31 obtains the sensor detection information. The generating unit 32 generates information that corresponds to the sensor detection information obtained by the obtaining unit 31 and that is included in the input information to be input to a generative AI. As a result, in a service in which messages are sent to and received from the user U in the form of a dialogue, the information processing device 1 becomes able to appropriately obtain the information about the user U.

Moreover, the obtaining unit 31 inputs, to a generative AI, the information containing the input information from the user U and obtains, from the generative AI, the output information corresponding to the input information. Based on the output information obtained by the obtaining unit 31, the display control unit 45 displays buttons in the terminal device 2. As a result, in a service in which messages are sent to and received from the user U in the form of a dialogue, the information processing device 1 becomes able to appropriately obtain the information about the user U.

Furthermore, the obtaining unit 31 includes: the first obtaining unit 40 that inputs, to the generative AI, the information containing the intent definition information, which is used to extract the intent type and the intent details from the input information, and containing the input information, and obtains, as the output information from the generative AI, the intent information containing the information indicating the intent type and the information indicating the intent details; and the second obtaining unit 41 that obtains the information corresponding to the information indicating the intent type and the information indicating the intent details as obtained by the first obtaining unit 40. Based on the information that is obtained by the second obtaining unit 41 and that corresponds to the information indicating the intent type and the information indicating the intent details, the generating unit 32 generates answer information. As a result, the information processing device 1 becomes able to appropriately provide a service in which messages are sent to and received from the user U in the form of a dialogue.

Moreover, the first obtaining unit 40 inputs, to the generative AI, the information that contains definition information, in which each of a plurality of functions is defined, as the intent definition information; and obtains, as the intent information from the generative AI, the function identification information that contains the information enabling identification of the information to be used in generating answer information from among a plurality of functions and the information indicating the arguments of the concerned function. As a result, the information processing device 1 becomes able to appropriately provide a service in which messages are sent to and received from the user U in the form of a dialogue.

The plurality of functions include a function related to a search, a function related to questioning, and a function related to a reservation. As a result, the information processing device 1 becomes able to appropriately provide a service in which messages are sent to and received from the user U in the form of a dialogue.

Moreover, the obtaining unit 31 obtains the location information as the sensor detection information. As a result, the information processing device 1 becomes able to appropriately provide a service in which messages are sent to and received from the user U in the form of a dialogue.

Furthermore, the obtaining unit 31 obtains the biological information of the user U as the sensor detection information. As a result, the information processing device 1 becomes able to appropriately provide a service in which messages are sent to and received from the user U in the form of a dialogue.

Herein, although the description is given about the embodiment of the application concerned, the technical scope of the present invention is not limited to the embodiment described above, and can be construed as embodying various deletions, alternative constructions, and modifications that may occur to one skilled in the art that fairly fall within the basic teaching herein set forth.

Moreover, the terms “section”, “module”, and “unit” mentioned above can be read as “device” or “circuit”. For example, an obtaining unit can be read as an obtaining device or an obtaining circuit.

According to an aspect of the embodiment, in a service in which messages are sent to and received from the user in the form of a dialogue, it becomes possible to appropriately obtain the information about the user.

What is claimed is:

1. An information processing device comprising:
a display control unit that displays, in a terminal device of a user, a button meant for obtaining, from the terminal device, sensor detection information in a service which is based on dialogue format using a generative AI that outputs answer information corresponding to input information;
a receiving unit that receives selection of the button as made by the user;
an obtaining unit that, when the receiving unit receives selection of the button, obtains the sensor detection information; and
a generating unit that generates information which corresponds to the sensor detection information obtained by the obtaining unit and which is included in input information to be input to the generative AI.

2. The information processing device according to claim 1, wherein
the obtaining unit inputs, to the generative AI, information containing input information from the user and obtains, from the generative AI, output information corresponding to the input information, and
based on the output information obtained by the obtaining unit, the display control unit displays the button in the terminal device.

3. The information processing device according to claim 2, wherein
the obtaining unit includes
a first obtaining unit that
inputs, to the generative AI, information containing intent definition information, which is meant for extracting intent type and intent details from the input information, and
obtains, as the output information from the generative AI, intent information containing information indicating the intent type and information indicating the intent details, and
a second obtaining unit that obtains information corresponding to information indicating the intent type and information indicating the intent details as obtained by the first obtaining unit, and
the generating unit generates the answer information based on information corresponding to the information indicating the intent type and information indicating the intent details as obtained by the second obtaining unit.

4. The information processing device according to claim 3, wherein the first obtaining unit
inputs, to the generative AI, information that contains definition information, in which each of a plurality of functions is defined, as the intent definition information, and
obtains, as the intent information, function identification information that contains
information enabling identification of function to be used in generating the answer information from among the plurality of functions, and
information indicating argument of concerned function.

5. The information processing device according to claim 4, wherein the plurality of functions include a function related to searching, a function related to questioning, and a function related to reservation.

6. The information processing device according to any one of claim 1, wherein the obtaining unit obtains location information as the sensor detection information.

7. The information processing device according to any one of claim 5, wherein the obtaining unit obtains biological information of the user as the sensor detection information.

8. An information processing method implemented in a computer, comprising:
display-controlling that includes displaying, in a terminal device of a user, a button meant for obtaining, from the terminal device, sensor detection information in a service which is based on dialogue format using a generative AI that outputs answer information corresponding to input information;
receiving selection of the button as made by the user;
obtaining that, when selection of the button is received at the receiving, includes obtaining the sensor detection information; and
generating information which corresponds to the sensor detection information obtained at the obtaining and which is included in input information to be input to the generative AI.

9. A non-transitory computer readable storage medium having stored an information processing program that causes a computer to execute:
display-controlling that includes displaying, in a terminal device of a user, a button meant for obtaining, from the terminal device, sensor detection information in a service which is based on dialogue format using a generative AI that outputs answer information corresponding to input information;
receiving selection of the button as made by the user;
obtaining that, when selection of the button is received at the receiving, includes obtaining the sensor detection information; and
generating information which corresponds to the sensor detection information obtained at the obtaining and which is included in input information to be input to the generative AI.
